(19) United States
(12) Patent Application Publication
(10) Pub. No.: US 2015/0348111 A1
(43) Pub. Date: Dec. 3, 2015

(54) SYSTEMS AND METHODS FOR PROVIDING AN ONLINE PUBLISHING PLATFORM

(71) Applicant: Next Gen Publishing Solutions, Inc., Cornelius, NC (US)

(72) Inventor: Nathan Horst Davis, Cornelius, NC (US)

(21) Appl. No.: 14/291,792

(22) Filed: May 30, 2014

(51) Int. Cl. G06Q 30/02

(52) U.S. Cl. CPC G06Q 30/0264

(57) ABSTRACT

Systems and methods are disclosed for providing an online publishing platform. The online publishing platform may host publications for a plurality of publishers. The publications may include a front-end portion that includes one or more articles and an advertiser marketplace. The front-end portion may be made accessible to end-users who access the publications. The publications may also include a back-end portion that can be accessed by publisher personnel. The back-end portion may include tools for managing the advertiser marketplace, as well a reverse publishing system that provides an end-to-end solution for creating and publishing articles.

### CROSS-REFERENCE TO RELATED APPLICATIONS

The present application is related to U.S. patent application Ser. No. ______ entitled “SYSTEMS AND METHODS FOR PROVIDING AN ONLINE PUBLISHING PLATFORM” (Attorney Docket 0368884.002) which is being filed concurrently with the present application, and which is incorporated herein by reference in its entirety.

### FIELD OF THE INVENTION

The present principles are directed to providing a publishing platform, and more particularly, to providing a cloud-based publishing platform that includes a collaborative reverse publishing system for generating articles and an advertiser marketplace that presents advertising content to end-users in a unique manner.

### BACKGROUND OF THE INVENTION

Over the past two decades, there has been a major shift in the way that individuals access news and other information. Traditionally, this information was obtained by purchasing printed publications, such as newspapers, magazines or other periodicals. With the introduction of the Internet, individuals were provided with widespread access to digital publications from their personal computing devices (e.g., desktop computers). This started a trend that resulted in many individuals switching from printed publications to online digital publications as their primary source of obtaining news and other information. The momentum of this trend has only grown stronger in recent years as mobile devices have become increasingly popular and less costly. As a result, many publishers now offer websites that permit individuals to access digital versions of the printed publications that are produced by the publishers.

Although many publishers now offer digital versions of their publications, the workflow or procedure used to create the articles for both the printed and digital publications has remained the same for the most part. Specifically, articles are still created using the traditional “newsroom” paradigm, in which an editor and publishing staff (e.g., reporters, photographers, etc.) work together in a newsroom at the publisher's office location to produce the article. All content associated with the article (e.g., text, photographs and graphics) is circulated among the individuals contributing to the article by e-mail or by printing out hard copies. Once the content of the article is finalized, the article is first prepared for inclusion in a printed publication. Thereafter, the article is converted into a digital version that can be included on the publisher's website. Hence, the workflow process used to create articles has remained the same, aside from adding an additional step to the end of the process which involves converting an article into a digital version and making the article available via the publisher's website.

Creating an article in this manner is inadequate for a number of reasons. Despite the growing trend associated with individuals accessing their news and other information from digital publications, the articles are still initially created for printed publications. Creating an article in this manner is backwards, inefficient and results in large overhead costs. It also tends to result in errors and/or omissions when the content is converted to a digital format. Moreover, the traditional workflow paradigm used to create the article content is antiquated and labor-intensive. There is very little automation when it comes to carrying out the various tasks involved with creating the article. Each individual that contributes to the article works in a vacuum and has limited access to the article content that is being contributed by others. Furthermore, the traditional workflow paradigm typically requires all of the contributors to be present at the same location in order to work together in producing the article.

Aside from the inadequacies associated with the workflow process that is utilized to create the articles, the publishers have also failed to adequately take advantage of advertising opportunities that present themselves in the realm of digital publications. This is especially true of “local” publishers that provide a publication that is intended primarily for readers in a particular geographic area. These publishers simply allow advertisers to purchase advertisements on their websites in a manner which is akin to the typical online digital advertising model that is used in nearly all industries. Specifically, the advertisers pay the publishers based on traditional compensation models, such as the cost-per-click (CPC) model or cost-per-view (CPV) model. Many advertisers do not wish to advertise using the typical online digital advertising model because the conversion rate is low and the model is not very effective. This results in lower revenues for the publishers and less effective advertising campaigns for the advertisers.

### SUMMARY OF THE INVENTION

An online publishing platform is disclosed that overcomes the obstacles and problems addressed above. The online publishing platform may host publications for one or more publishers. The publications may include a front-end portion that includes one or more articles and an advertiser marketplace. The front-end portion may be made accessible to end-users who access the publications. The publications may also include a back-end portion that can be accessed by publisher personnel (e.g., employees or independent contractors who work for the publishers). The back-end portion may include tools for managing the advertiser marketplace, as well a reverse publishing system that provides an end-to-end solution for creating and publishing articles.

In accordance with certain embodiments of the present invention, systems and methods are disclosed for presenting advertiser content to end-users via an online publication. Access is provided to an advertiser marketplace that comprises a plurality of interfaces that are configured to display separate categories of advertiser content. The categories of advertiser content may include categories associated with coupon information, photo album information, event and promotion calendar information and directory listing information. Profile information is stored for a plurality of advertisers. The profile information may include information pertaining to the categories of advertiser content and start date information indicating when the advertisers created user accounts associated with the advertiser marketplace. A request is received from an end-user to display an interface associated with the advertiser marketplace. Advertiser content may be aggregated for a plurality of advertisers that includes a subset of the stored profile information that pertains to a category of the advertiser content that is associated with the interface identified by the end-user's request. A listing of entries is output for display to the end-user that includes the aggregated advertiser content. The entries in the listing are ordered, at least in part, by assigning priority rankings to the advertisers based on advertising expenditures, identifying advertisers that are assigned an identical priority ranking, and utilizing the start dates to determine which of the identified advertisers are to be given a higher priority ranking.

In accordance with certain embodiments of the present invention, systems and methods are disclosed for providing a reverse publishing service for creating articles. Access over a network is provided to a reverse publishing platform that includes interfaces for managing a workflow associated with creating articles. Role information for a plurality of article contributors is stored on a server associated with the reverse publishing platform. The role information associates an editorial role with an editorial contributor and a content contributor role with a set of content contributors (e.g., authors, photographers and/or graphic designers) that include authors, photographers or graphic designers. An article submission is received for creating a new article. In response to a selection received from the editorial contributor, a crowd source request is transmitted to the set of content contributors to identify content contributors who are available and willing to perform a task associated with generating content for the article. Based on feedback provided by the set of content contributors, a selection is received from the editorial contributor that identifies a selected content contributor that is assigned the task. Article content associated with the task is then received from the selected content contributor. A digital version of the article is created and integrated into a digital publication. The digital version of the article may then be converted into a format that is compatible with a printed publication.

These and other features and advantages will become apparent from the following detailed description of illustrative embodiments thereof, which is to be read in connection with the accompanying drawings.

### BRIEF DESCRIPTION OF THE DRAWINGS

The inventive principles are illustrated in the figures of the accompanying drawings which are meant to be exemplary and not limiting, in which like references are intended to refer to like or corresponding parts, and in which:

FIG. 1 is a block diagram of a publishing system in accordance with certain embodiments of the present invention.

FIG. 2 is a conceptual diagram illustrating the flow of advertiser information throughout the advertiser marketplace in accordance with certain embodiments of the present invention.

FIG. 3 is an interface associated with an advertiser homepage in accordance with certain embodiments of the present invention.

FIG. 4 is an interface associated with a local directory that includes advertiser information for a plurality of advertisers in accordance with certain embodiments of the present invention.

FIG. 5 is an interface associated with an event and promotion calendar that includes advertiser information for a plurality of advertisers in accordance with certain embodiments of the present invention.

FIG. 6 is an interface that includes photo albums listings for a plurality of advertisers in accordance with certain embodiments of the present invention.

FIG. 7 is an interface that includes coupons for a plurality of advertisers in accordance with certain embodiments of the present invention.

FIG. 8 is an interface for managing advertiser accounts in accordance with certain embodiments of the present invention.

FIG. 9 is an interface for creating an advertiser account in accordance with certain embodiments of the present invention.

FIG. 10 is an interface for viewing and editing a selected advertiser account in accordance with certain embodiments of the present invention.

FIG. 11 is an interface for managing contracts associated with advertiser accounts in accordance with certain embodiments of the present invention.

FIG. 12 is an interface for managing entertainers in accordance with certain embodiments of the present invention.

FIG. 13 is an interface for managing an event and promotion calendar for a selected advertiser in accordance with certain embodiments of the present invention.

FIG. 14 is an interface for displaying upcoming photography requests in accordance with certain embodiments of the present invention.

FIG. 15 is an interface for assigning photographers to photography requests in accordance with certain embodiments of the present invention.

FIG. 16 is an interface for displaying completed photo albums in accordance with certain embodiments of the present invention.

FIG. 17 is an interface for displaying statistics associated with photo albums in accordance with certain embodiments of the present invention.

FIG. 18 is an interface for managing coupons for a selected advertiser in accordance with certain embodiments of the present invention.

FIG. 19 is an interface for adding a new coupon in accordance with certain embodiments of the present invention.

FIG. 20 is an interface for submitting a banner request in accordance with certain embodiments of the present invention.

FIG. 21 is an interface for creating an advertiser contract in accordance with certain embodiments of the present invention.

FIG. 22 is an interface for displaying a listing of employee profiles for a publication in accordance with certain embodiments of the present invention.

FIG. 22A is an interface for editing a selected employee profile in accordance with certain embodiments of the present invention.

FIG. 23 is an interface for creating a new article in accordance with certain embodiments of the present invention.

FIG. 24 is an interface indicating the status of articles in accordance with certain embodiments of the present invention.

FIG. 25 is an interface for adding content to an article in accordance with certain embodiments of the present invention.

FIG. 26 is an interface for managing articles for a publication in accordance with certain embodiments of the present invention.

FIG. 27 is an interface for managing the positioning of featured articles in accordance with certain embodiments of the present invention.

FIG. 28 is an interface for displaying statistical information associated with articles in a publication in accordance with certain embodiments of the present invention.

FIG. 29 is an interface illustrating a listing of pending articles organized according to their workflow stage in accordance with certain embodiments of the present invention.

FIG. 30 is a flow chart of a method for providing an advertiser marketplace in accordance with certain embodiments of the present invention.

FIG. 31 is a flow chart of a method for providing a reverse publishing system in accordance with certain embodiments of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

In accordance with certain embodiments, an online publishing platform is disclosed that provides a cloud-based software as a service (SaaS) solution that provides comprehensive business process management (BPM) services for one or more of publishers. The online publishing platform may host one or more publications for each of the publishers. Each publication may be associated with a front-end portion and a back-end portion. The front-end portion may display articles and other content to end-users who access the publication. The back-end portion provides the publishers with tools for managing the publication, including tools for creating and updating articles and tools for managing a dynamic marketplace for advertisers which is accessible to end-users via the front-end portion of the publication.

In certain embodiments, the online publishing platform provides an advertiser marketplace that provides various marketing opportunities that extend far beyond traditional online advertising models (e.g., CPC or CPV models). Initially, advertisers (e.g., businesses or organizations) may setup user accounts with the publishers to take advantage of these marketing opportunities. Each user account may be associated with a profile that includes categories of different advertiser content. For example, in certain embodiments, the profile information associated with each advertiser may include company information, an event and promotion calendar, coupons and photo albums. This profile information may be parsed into separate streams and aggregated with similar content provided by other advertisers. The aggregated advertiser content may then be presented on separate interfaces that are specific to each of the advertising categories. More specifically, the aggregated advertiser content may be presented as a listing of entries on each of the interfaces.

While every advertiser desires to appear at the top of the listings presented on the interfaces in order to their promote visibility and accessibility to end-users, the advertiser marketplace utilizes a unique ordering procedure that orders the entries in the listings in a manner that promotes advertiser loyalty and creates increased revenue for the publishers. As explained in further detail below, the ordering procedure takes into account both the amounts that the advertisers spend on marketing activities and the duration of the advertisers' relationship with the publishers. In certain embodiments, the ordering procedure may also take into account whether any of the advertisers have purchased featured advertisements that allow the advertisers to temporarily obtain a better position in the listings. Because the duration of the advertisers' relationship with the publishers is accounted for in the ordering algorithm, the advertisers are rewarded for maintaining advertising accounts with the publishers for extended periods of time, thus resulting in greater revenues for the advertisers and increased exposure for the advertisers who are loyal to the publishers.

In addition to attracting advertisers and increasing revenues for the publishers, the online publishing platform also provides the publishers with a reverse publishing system that enables the publishers to generate articles and other content in an automated fashion and with minimal overhead costs. In contrast to traditional publishing systems, the reverse publishing system initially generates content for digital publications and, thereafter, permits the content to be converted to a format for inclusion in printed publications. The entire workflow process associated with creating the content may be automated in the cloud and all data associated with the creation of the content may be stored in a centralized location. Thus, the individuals associated with the content creation process may access the current draft or version of the content at any time and from any location using a client device (e.g., laptop or desktop computer). There is no need for individuals to be located in a single geographic location. Moreover, the assignment of roles assigned to the individuals involved with the creation process permits automated control of the content during the creation process. Content can be created in a uniform manner using the interfaces and associated forms that are displayed to the individuals. Once the content is finalized, the content can be instantly published to the digital version of the publication that is hosted by the online publishing platform and/or converted to format for inclusion in a printed publication.

The reverse publishing system permits content to be created using two separate development models (or a combination of the two). First, the reverse publishing system can provide an automated version of the traditional newsroom creation model in which an editor manually assigns different tasks to individuals. However, in contrast to the traditional approach, the reverse publishing system provides an SaaS solution that automates the workflow and which makes all content being created accessible from a centralized location. The individuals working to create the content may be, but are not required to be, located at the same location.

In addition, the reverse publishing system also permits the process of creating the content to be shifted to a “crowd sourcing” or “bring your own device” (BYOD) model. This model permits an editor or other individual to send requests to a pool of individuals (e.g., a group of photographers, group of journalists or group of graphic designers) for assistance with executing different tasks associated with the creation of the content. The individuals who receive the requests may indicate their availability with respect to fulfilling the request. Based on the feedback received from the individuals, the editor may assign or allocate the task associated with the request to the individual best suited to perform the task. For example, in the case of a breaking story, the editor may receive five responses from photographers indicating that they are available to cover the story, but the editor may select the photographer that is able to arrive earliest on the scene. The individuals who have been allocated tasks can then login to the reverse publishing system and provide content associated with the execution of the task. Content for the article may be created in this manner without ever requiring the individuals working on the content to meet in a single location. For example, a plurality of independent contractors who are located remotely with respect to the publisher's location can easily contribute content to an article without ever being required to meet with the publishing staff in person.

The embodiments described in this disclosure can be combined in various ways. Any aspect or feature that is described for one embodiment can be incorporated to any other embodiment mentioned in this disclosure. Moreover, any of the embodiments described herein may be hardware-based, software-based and preferably comprise a mixture of both hardware and software elements. Thus, while the description herein may describe certain embodiments, features or components as being implemented in software or hardware, it should be recognized that any embodiment, feature or component that is described in the present application may be implemented in hardware and/or software. In certain embodiments, particular aspects are implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer-readable medium may include any apparatus that stores, communicates, propagates or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

### I. Exemplary System Architecture

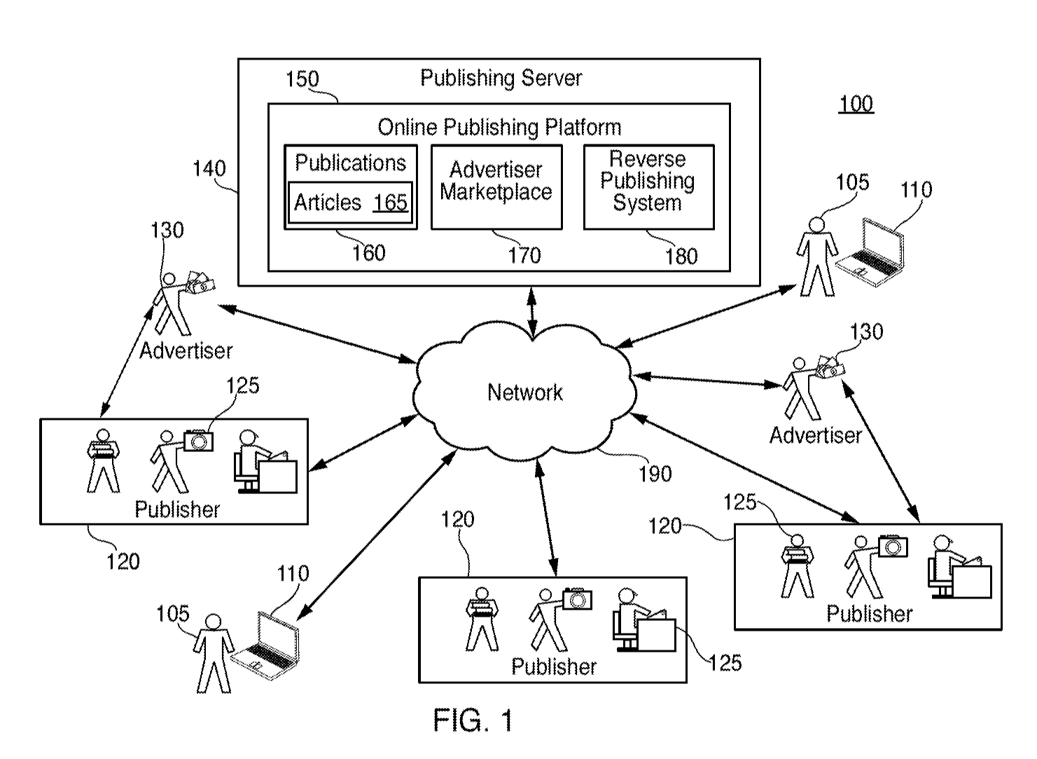

FIG. 1 illustrates a publishing system 100 that provides publishing services to a plurality of publishers 120. The system 100 includes one or more servers 150 that comprises an online publishing platform 150. The online publishing platform 150 may host publications 160 for a plurality of publishers 120. The publications 160 may include digital newspapers, magazines, journals, blogs, periodicals, social media publications or other types of digital publications. The online publishing platform 150 is accessible to publishers 120, advertisers 130 and end-users 105 over a network 190. The network 190 may be any type of network such as one that includes the Internet, a local area network (LAN), a wide area network (WAN), an intranet, and/or other network. The publishers 120, advertisers 130 and end-users 105 may communicate with the online publishing platform 150 over the network 190 using client devices 110. The client devices 110, as well as the server 140, may be configured to communicate via wired or wireless links, or a combination of the two.

The client devices 110 may represent a desktop computer, laptop computer, cell phone, tablet device, personal digital assistant (PDA) or other type of computing device that is capable of communicating with the server 140. Each of the client devices 110 may be equipped with one or more computer storage devices (e.g., RAM, ROM, PROM, SRAM, etc.) and one or more processing devices (e.g., a central processing unit) that are capable of executing computer program instructions. The computer storage device is preferably a physical, non-transitory medium. Any of the client devices 110 may further include a display that is capable of rendering interfaces and one or more input devices (e.g., keyboard, microphone, camera, touch screen, video camera, scanner, joystick, remote control device, etc.). Users may manipulate or interact with the interfaces rendered on the display using the input devices in order to communicate with the server 140.

The publishing server 140 may also include one or more processors and one or more computer storage devices. The computer storage device is preferably a physical, non-transitory medium. The publishing server 140 may generally represent any type of computing device that is capable of communicating with a client device 110 over the network 190. In some embodiments, the publishing server 140 comprises one or more mainframe computing devices that execute a web server for communicating with client devices 110 over the Internet. The storage medium associated with the publishing server 140 can store applications, instructions and software code that are configured to implement any functionality of the online publishing platform 150 that is mentioned in this disclosure including, but not limited to, functionalities associated with providing an advertiser marketplace 170 and a reverse publishing system 180 for one or more publications 160.

In certain embodiments, the online publishing platform 150 may represent a cloud-based SaaS solution that provides comprehensive business process management BPM services for a plurality of publishers 120. Each publication 160 may be associated with a back-end portion and a front-end portion of a publication 160. The front-end portion of the publications 160 that permit the end-users 105 to access the publications 160 and to view articles 165 associated with the publications 160. For example, an end-user 105 may access a front-end portion of the publication 160 by navigating to a uniform resource locator (URL) or website associated with the publication 160. The front-end portion of the publications may also include other advertiser content (e.g., advertiser information, coupons, photos and/or event information) that is associated with one or more advertisers 130.

The back-end portion of a publication 160, which is not accessible to the general public, may permit a publisher 120 to create, edit, update and manage the publication 160. For example, publisher personnel 125 associated with a publisher 120 may login into the account to customize aspects of the publication 160 (e.g., by uploading logos, designing interface layouts and selecting color schemes) and to create content (e.g., articles) for the publication 160. The publisher personnel 125 may also access interfaces that permit them to create, edit, update and manage content for advertisers 130. The publisher personnel 125 may include executive editors, department editors, authors, photographers, graphic designers, content editors, layout editors, videographers, administrators and any other individuals that provide assistance with creating, updating, maintaining or managing a publication 160 for a publisher 120 or with providing services to assist the advertisers 130. Moreover, the publisher personnel 125 may include employees, staff or independent contractors that work for the publisher 120.

As explained in further detail below, the back-end portion of a publication 160 further includes a collaborative reverse publishing system 180 that permits the publisher personnel 125 to create and publish articles 165 and other content for the publications 160. The reverse publishing system 180 may provide interfaces to the publisher personnel 125 which are displayed on client devices 110 being operated by the publisher personnel 125. The interfaces may permit the publisher personnel 125 to control each stage of the workflow process (e.g., creation, review, update and approval stages) associated with creating or updating an article 165 or piece of content for the publication 160. The assignment of roles to the publisher personnel 125 may control the manner in which the article 165 or content proceeds through the various stages of the workflow process and may be used to determine which individuals have access to the article content at each stage. The cloud-based publishing platform 150 may enable the publisher personnel 125 (e.g., authors, editors and photographers) to collaborate in creating or updating an article 165 without requiring the personnel 125 to be in the same location. Instead, the publisher personnel 125 may access the article content from any geographic location using a client device 110. An article 165, or other piece of content created by the reverse publishing system 180, may initially be created for output in a digital or “web-ready” form that can be included in the publication 160 that is hosted by the online publishing platform 150. The digital content can be then be easily exported to a format for inclusion in a printed publication for a publisher 120. In certain embodiments, the articles and/or printed publication may be printed directly by the publisher and/or may be forwarded to a printing company by selecting on option provided by the reverse publishing system 180.

In addition to displaying articles 165 and other related content, the front-end portion of a publication 160 on the publishing platform 150 may also display advertiser content associated with one or more advertisers 130. For example, the advertiser content that is displayed may include information identifying a company's name, address, phone number, website, hours of operation, business description and social media information. The advertiser content may further include coupons (and other related promotional content associated with discounts, sales, vouchers, etc.) that are being offered by advertisers 130, event and promotion calendars that display information pertaining to events and promotions being held by the advertisers 130, and multimedia content (e.g., images, photos, videos and animations) associated with the advertisers 130. Hyperlinks may also be provided which link to websites for the advertiser 130 or to social media (e.g., Facebook™, Twitter™ or LinkedIn™) pages associated with the advertiser 130. The advertiser content may also include any other data or content associated with the advertisers 130.

In certain embodiments, the advertisers 130 may represent businesses, organizations, individuals, educational institutions or other entities. In certain embodiments, the advertisers 130 may represent entities that are located in a geographic area that is local with respect to a primary audience for a publication 160. For example, if the online publishing platform 150 was utilized to create a publication that disseminated information about nightlife in the New York City area, the advertisers 130 may represent local businesses or entities located in the New York City area. The advertisers 130 may pay the publishers 120 to include advertising content in the publications 160. The payments may be submitted to the advertisers 130 through the online publishing platform 150 (e.g., using a web form accessible via accounts for the advertisers 130) or submitted directly to the advertisers 130.

In certain embodiments, the advertisers 130 may be permitted to create an account that is associated with one or more publications 160 that are hosted on the online publishing platform 150. An account associated with an advertiser 130 may permit the advertiser, publisher personnel 125 or other individual to create and edit the advertiser content that is included in a publication 160, upload multimedia content and submit payments to the publishers 120. In certain embodiments, the back-end portion of a publication 160 may include tools that permit the publisher personnel 125 or advertisers 130 to add, edit, delete or otherwise manipulate the advertiser content included in a publication 160.

As explained in further detail below, the online publishing platform 150 may provide an advertiser marketplace 170 that may be viewed as an enhanced, digital phonebook for the modern world that is easily scalable to accommodate listings for any number of advertisers 130. The advertiser marketplace 170 may be configured to aggregate advertiser content associated with a plurality of advertisers 130, process the advertiser content and output the advertiser content to end-users 105 (e.g., article readers or any other individuals that access the online publishing platform 150). More specifically, the online publishing platform 150 permits profiles to be set up for the advertisers 130 which include, inter alia, company information associated with the advertisers 130 (e.g., company name, contact information, description of products or services and social media links), a calendar of upcoming events and promotions for the advertisers 130, coupons being offered by the advertisers 130 and photo albums for the advertisers 130. This profile information may be extracted into separate streams and presented on separate interfaces that are specific to certain advertising categories. For example, the coupon content provided by each of the advertisers 130 may be extracted from the stored profile information and presented on one interface, while the event information provided by the advertisers 130 may be extracted and presented on another interface. The advertiser content may be presented as a listing of entries on each of the interfaces. As explained in further detail below, a unique process may be executed to determine the manner in which the entries on the interfaces are ordered and presented to the end-users 105 for display.

As explained in further detail below, both the advertiser marketplace 170 and the reverse publishing system 180 may include crowd sourcing features that permit the publishers 120 and/or advertisers 130 to utilize a “labor pool” that may be comprised of publisher personnel 125 (including both employees and independent contractors) and/or third parties in order to accomplish certain tasks. For example, in the context of the reverse publishing system 180, the crowd sourcing features may be used to assign individuals (e.g., photographers and graphic designers) to handle certain tasks associated with creating an article 165. Similarly, in the content of the advertiser marketplace 170, the crowd sourcing features may be used to schedule individuals (e.g., entertainers or photographers) to attend events that are hosted by the advertisers and to supplement existing advertiser content made available via the advertiser marketplace 170.

It should be noted that the system in FIG. 1 is merely meant to demonstrate an embodiment of an operating environment that can be utilized in conjunction with the invention described herein, and should not be construed as limiting in any manner. The particular configuration in FIG. 1 can be altered in numerous ways without departing from the principles herein. For example, it should be noted that the functionality of the publishing server 140 may be carried out by a plurality of servers. In fact, any number of publishing servers 140 and client devices 110 may be utilized with the system and the system may be configured in a variety of different ways (e.g., in a distributed computing environment, cloud-based environment, client-server environment, etc.).

Furthermore, while FIG. 1 illustrates a plurality of client devices 110 in communication with a server 140 over a network 190, it should be recognized that the functionality provided by the server 140 to the client devices 110 may be performed locally on each of the client devices 110. For example, in certain embodiments, the online publishing platform 150 may reside locally on one or more client devices 110. Thus, any functionality of the server 140 which is described herein can alternatively be implemented by a client device 110, and vice versa.

Even further, although this disclosure may provide examples in which the publishers 120 and advertisers 130 comprise businesses or companies, the publishers 120 and advertisers 130 may represent any individual or entity (e.g., organizations, charity or educational institution). For example, in certain cases, an advertiser 130 may represent an educational facility that desires to advertise with a local publication to notify end-users 105 about school events (e.g., sporting events, recitals, plays or graduation ceremonies) and by posting photo albums. Similarly, an educational facility may also represent a publisher 120 that desires to disseminate a publication 160 that pertains to the school and separate advertiser 130 accounts may be setup for different groups of students (e.g., basketball team, drama club and faculty). Other types of variations are also contemplated.

### II. Exemplary Embodiments for an Advertiser Marketplace

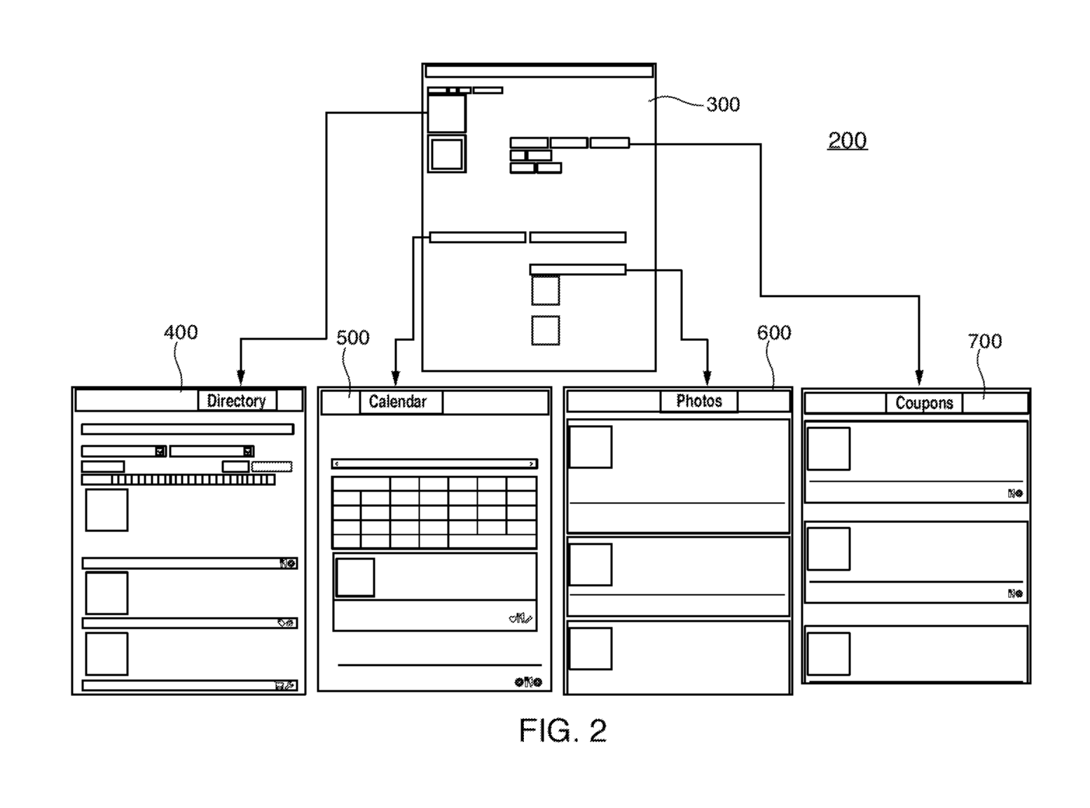

FIG. 2 is a conceptual diagram 200 that illustrates the flow of advertiser content throughout an advertiser marketplace 170 for an exemplary publication 160 in accordance with certain embodiments of the present invention. More particularly, this figure illustrates advertiser content flowing from a homepage interface 300 associated with an advertiser's 130 profile to four interfaces that are configured to provide different types of marketing features: a local directory interface 400, event and promotion calendar interface 500, photo album interface 600 and coupon interface 700. In certain embodiments, the five interfaces shown in FIG. 2 (and any associated functionality and data) collectively represent the advertiser marketplace 170 that is provided by the online publishing platform 150.

As shown therein, the advertiser content associated with the advertiser's 130 profile or homepage 300 is parsed into different advertising categories (e.g., photos, coupons, events and directory listings) and aggregated into separate streams along with advertiser content associated with other advertisers 130. The streams, which include the aggregated advertiser content, may then be presented to end-users 105 that access the interfaces. End-users 105 may view and/or interact with any of these interfaces over the network 190 (e.g., using client devices 110) to access and obtain various types of advertising information.

The manner in which the aggregated streams of advertiser content are generated may vary. In certain embodiments, the aggregated streams may be generated in real-time in response to an end-user 110 accessing the interfaces associated with the advertiser marketplace 170. For example, in response to an end-user 105 accessing the photo album interface 600, the profile information associated with advertisers' photo albums may be dynamically retrieved, aggregated to create a stream of advertising information and presented on the interface 600 to the end-user 105. In certain embodiments, the aggregated streams of advertiser information may be generated by the advertiser marketplace 170 at periodic intervals (e.g., once per day or week) and stored for subsequent retrieval. In certain embodiments, the aggregated streams may be generated on-demand after publisher personnel 125 has logged into the back-end portion of a publication 160 and provided an indication that the stream of advertiser information should be created or updated (e.g., by selecting a button or other element on an interface that initiates the creation or updating of one or more of the streams).

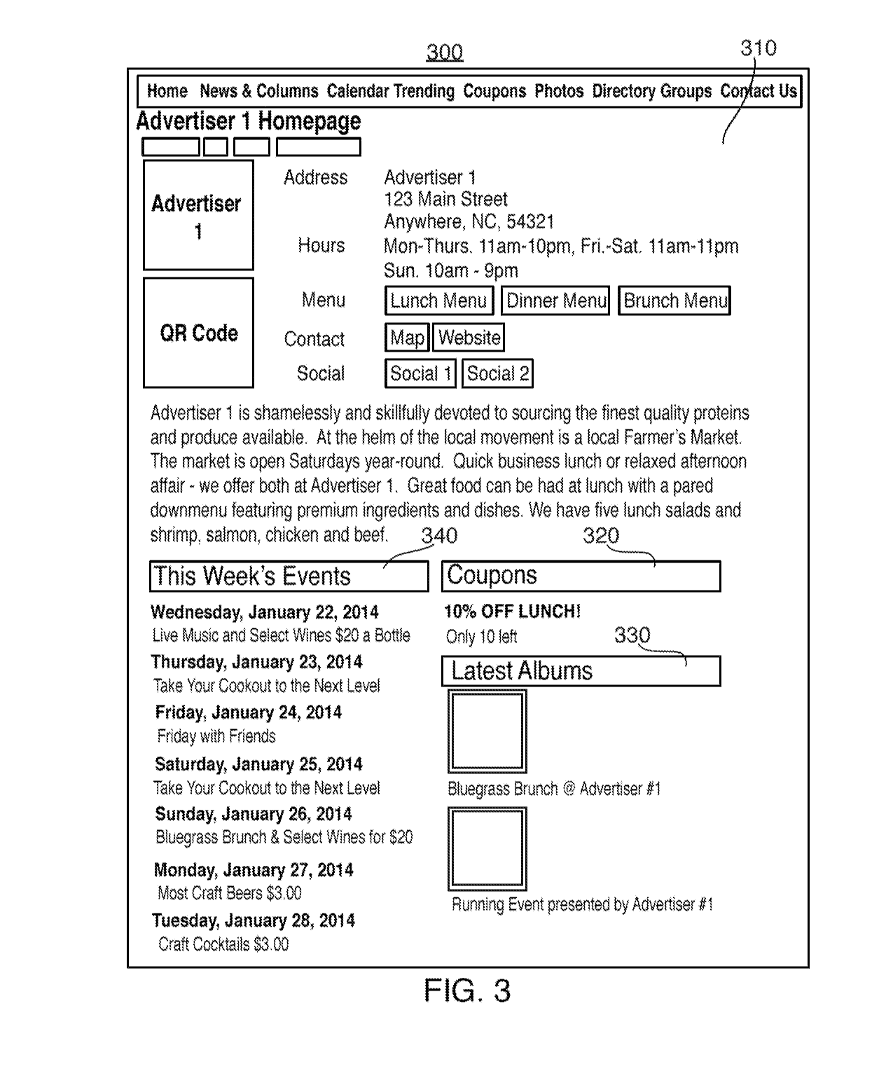

As will be apparent from the description of FIGS. 3-7 provided below, the interfaces 400, 500, 600 and 700 each provide a listing of entries that include advertising content for a particular advertising category. For example, the coupons interface 700 includes a listing of coupons that are being offered by the advertisers 130 and the photo album interface 600 includes a listing of photo albums that are associated with the advertisers 130. While all of the advertisers 130 desire their entries to be located at the top of the listings in order to promote their visibility and accessibility to end-users 105, the advertiser marketplace 170 employs a sorting procedure for ordering the entries which takes into account, inter alia, marketing expenditures and loyalty of the advertisers 130.

The advertiser marketplace 170 is configured to sort or order the entries displayed on the interfaces 400, 500, 600 and 700 in accordance with a particular ordering process or procedure. To facilitate the ordering of the entries, an initial priority ranking may be assigned to each of the advertisers 130. In certain embodiments, the priority rankings may be determined based on the amount of money spent by the advertisers 130, or paid to the publishers 120, for marketing activities. The advertisers 130 may spend money for various types of marketing activities. For example, a plurality of tiered marketing plans may be purchased, each of which varies in price and which comes with different marketing options. Advertisers 130 may purchase a particular marketing plan and/or other marketing activities (e.g., associated with hiring a photographer or entertainer, purchasing banner advertisements to be displayed on the publication 160 or other related activities). The online publishing platform 150 may permit the advertisers 130 and publishers 120 to engage in contracts associated with any purchased marketing activity. The advertising expenditures for the advertisers 130 will be used to determine the priority ranking for the advertiser 130. Advertisers 130 that spend larger amounts may be given a higher priority ranking in comparison to advertisers 130 that spend smaller amounts.

The manner in which the advertising expenditures for an advertiser 130 are calculated may vary. In certain embodiments, the priority ranking may be determined based on the total amount being spent by the advertiser 130 on all pending or current contracts that exist between the advertiser 130 and the publisher 120. In certain embodiments, the priority ranking may be determined based on the total amount spent by the advertiser 130 since the advertiser 130 created an account with a publication 160 hosted on the online publishing platform 150. In certain embodiments, the priority ranking may be determined based on the total amount spent by the advertiser 130 during a particular period of time (e.g., the amount spent over the previous month or year).

After the initial priority rankings are assigned to each of the advertisers 130, there may be instances where the same priority ranking is assigned to a plurality of advertisers 130 (e.g., if two advertisers 130 are paying the same amount or are paying an amount that falls within a particular range associated with a particular priority ranking). In order to determine which advertiser should be given a higher priority with respect to the ordering of entries included in the listings displayed on interfaces 400, 500, 600 and 700, the advertiser marketplace 170 will look at the “start date” for each of the advertisers 130. The start date for an advertiser 130 may be retrieved from an advertiser's stored profile information and may indicate when the advertiser 130 initially created an advertising account with the publication 160 (or, in some cases, may indicate when the status of the account was last changed from “inactive” to “active” as described in further detail below). The advertisers 130 having earlier start dates will be given higher priority in comparison to advertisers 130 having later start dates. Thus, in the case that two advertisers 130 are assigned the same initial priority ranking, the advertiser 130 having the earlier start date will be given higher priority and will appear first in the listings provided on the interfaces 400, 500, 600 and 700.

Ordering the entries in the above manner incentivizes the advertisers 130 to make the largest possible advertising expenditures in order to promote the visibility of their advertising content. In addition, by considering the start dates of the advertiser accounts, advertisers 130 who have had longstanding relationships with the publishers 120 are rewarded and given an added incentive to maintain a future relationship with the publishers 120.

As explained above, the amount of money spent by the advertisers 130 and the duration of the advertisers' 130 relationship with a publication 160 may affect the advertisers' 130 priority rankings with respect to the listings that are displayed via the advertiser marketplace 170. In certain embodiments, other factors may affect the advertisers' priority rankings and the ordering of the entries included in the listings. For example, in certain embodiments, an advertiser 130 may be permitted to purchase a featured advertisement that temporarily lists an entry associated with the advertiser 130 at the top of one or more of the listings provided by the advertiser marketplace 170, regardless of the priority ranking that otherwise would have been assigned to the advertiser 130. For example, an advertiser 130 that purchased a featured advertisement may be placed at the top of the listing for a particular day, week or month, even if the advertiser 130 had otherwise spent very little on marketing activities. In the case that two or more advertisers 130 purchased featured advertisements for the same period of time, the start dates of the advertisers 130 may be used to determine which advertisers 130 are to be given a higher priority ranking. Thus, if two advertisers 130 both purchased featured advertisements, the advertiser 130 having the earlier start date would appear first in the listing.

In certain embodiments, the interfaces 400, 500, 600 and 700 may display filtering options that may be selected by end-users 105 to narrow the entries in the listings to particular types of content. Exemplary filtering options may permit an end-user 105 to filter the entries in the listings based on the advertisers' 130 type of business or organization (e.g., restaurants, automotive dealers, bars, government-related, charity-related, education, real estate, sports and/or retail), the neighborhood (e.g., village, town, city or sub-section of the same) or location of the advertisers 130, dates and times associated with the entries in the listings (e.g., indicating when an entry was posted or when an event took place), venues associated with an event or entry, entertainment (e.g., musicians, artists, celebrity appearances or other types of entertainers) associated with an event or entry, the types of products and services offered by the advertisers 130, or other criteria.

After an end-user 105 has selected a filtering option on an interface provided by the advertiser marketplace 170, the entries included on the associated listing may be filtered or narrowed based on the option that was selected. For example, the entries in the listing may be narrowed to only include restaurants entries in the case that the end-user 105 selected a particular filtering option associated with restaurant businesses. Regardless of which filtering option was selected by the end-user 105, the filtered listing of entries would still be sorted or ordered in the same manner as described herein. For example, the filtered listing may display a listing of entries that are ordered based on marketing expenditures and the start dates for the advertisers 130, while temporarily promoting entries associated with featured advertisements to the top of the listing.

It should be noted that other types of advertiser content may be associated with the profile information or homepage for an advertiser 130, and that additional interfaces may be incorporated into the advertiser marketplace 170 in order to display this information. For example, in certain embodiments, the advertisers' 130 profile information or homepage video content, audio content, or other content that is associated with the advertisers 130 may be displayed. This additional advertiser content may then be extracted, aggregated and presented separate interfaces that are provided by the application marketplace 170. Other variations are also contemplated.

FIGS. 3-7 illustrate each of the interfaces shown in FIG. 2 in further detail. FIG. 3 is an exemplary homepage interface 300 that may be provided for an advertiser 130 that has an account with a publication 160 hosted on the online publishing platform 150. The advertiser 130 and/or publisher personnel 125 may input or provide the profile information displayed on this interface (e.g., via the back-end portion of the publication 160). This profile information may be stored on the online publishing platform 150. As explained above, the advertiser marketplace 170 may be configured to extract portions of this profile information, aggregate the profile information with similar information provided by other advertisers and present this information on different interfaces 400, 500, 600 and 700.

The interface 300 includes a company information section 310, a coupons section 320, a photo album section 330 and an events section 340. The company information section 310 of the interface 300 includes general information about the advertiser's 130 company or business. For example, the company information section 310 may indicate the company's name, address, hours of operation, contact information (e.g., phone number and e-mail address), website and social media information (e.g., links to the advertiser's 130 account on Facebook™, Twitter™, LinkedIn™ or other social media platform). The company information section 310 may provide links to any information that is relevant to the advertiser's 130 business. For example, if the advertiser 130 is a restaurant or other business that serves food, links may also be provided to menus. Similarly, links may be provided to an inventory of available cars in the case that the advertiser 130 is a car dealership or a price listing for beauty products in the case that the advertiser 130 is a beauty salon. In some instances, the links may also be provided to news stories and editorial articles that pertain to the advertiser 130. The company information section 310 may also include a description of the company's business (and/or related products and services), a quick response (QR) code associated with the company, an image or logo associated with the business, and other relevant information. In certain embodiments, the company information section 310 may further include a “send to phone” option that is configured to transmit the advertiser's 130 contact information (e.g., company name, phone number, street address, website and e-mail address) to an end-user's 105 phone to permit the end-user 105 to save the advertiser in his or her listing of contacts. An end-user 105 may subsequently access the stored contact information to place a phone call to the advertiser 130, to send an e-mail to the advertiser 130, or to view the advertiser's 130 location (e.g., using GPS coordinates) on the phone.

The events section 340 includes a listing of upcoming events and promotions that are being provided or offered by the advertiser 130. The coupons section 320 includes a listing of coupons (e.g., discounts, sales vouchers or related promotional content) that are being offered by the advertiser 130. The photo album section 330 includes a listing of photo albums associated with the advertiser 130. In some cases, the photo albums may include images or pictures from events that were hosted by the advertiser 130. As explained in further detail below, the online publishing platform 150 not only assists with advertising the events that are hosted by the advertisers 130, but also assists advertisers 130 with obtaining photographers to create photo albums for the events (or for another purpose) and subsequently making the photo albums available on the homepage interface 300.

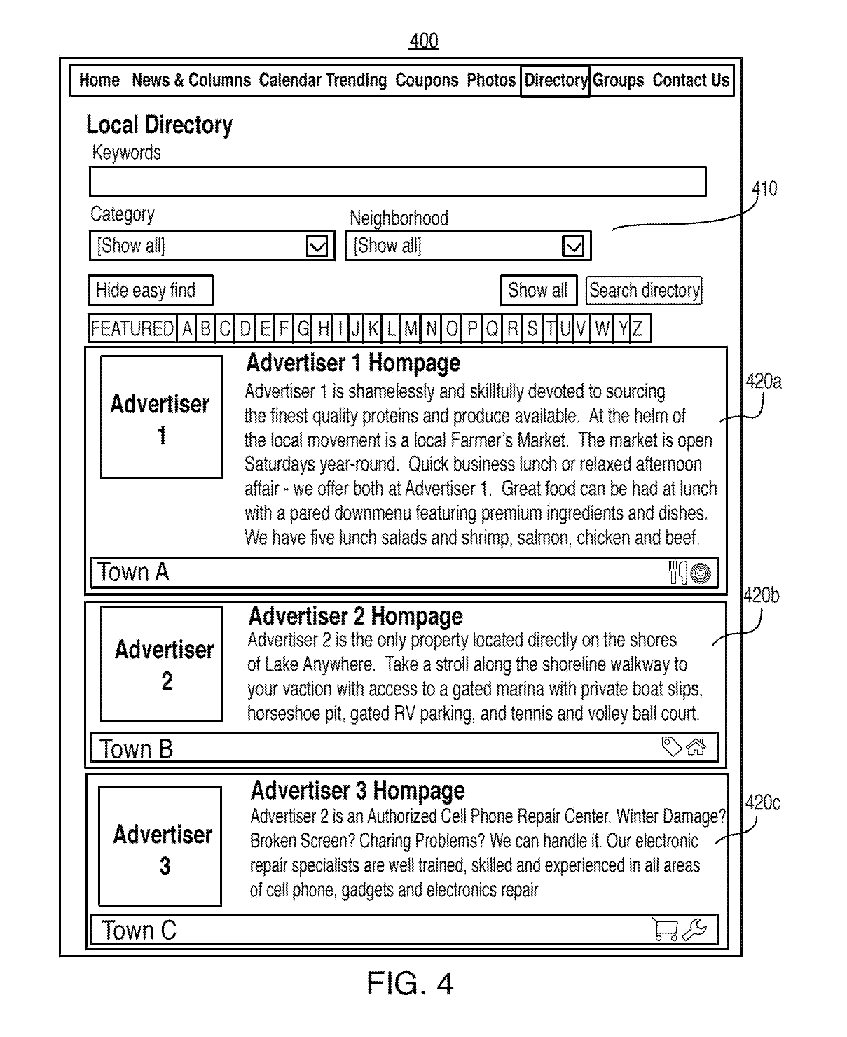

FIG. 4 is an exemplary directory interface 400 that includes a listing of advertisers 130. The listing of advertisers 130 includes entries 420a, 420b and 420c. An end-user 105 may scroll down (e.g., using a mouse) to view additional entries. The entries in the listing may be ordered based on the expenditure amounts for the advertisers 130, the start dates of the advertisers' 130 accounts and/or whether the advertiser 130 has paid for a featured advertisement. Each entry may include information that is displayed in the company information section 310 of the associated advertiser's 130 homepage. In this example, the entries include a logo or image associated with an advertiser 130, a name and description of the advertiser 130, a location of the advertiser (e.g., “Town A”) and a link to the advertiser's homepage. An end-user 105 may select an entry to view the homepage interface 300 associated with the entry.

Filtering options are located at the bottom of each entry. A first filtering option is associated with the advertisers' 130 locations. In response to an end user 105 selecting the location-based filtering options, the entries included in the listing will be filtered such that the listing will only include entries for advertisers 130 that are associated with the selected location. For example, if an end-user 105 selected “Town A” (e.g., by clicking it with a mouse or selecting it on a touch screen device), then the listing would display entries for advertisers 130 that are located in Town A. The end-user 105 could filter the listing in a similar manner using the “Neighborhood” filter located in the search portion 410 of the interface 400.

A second filtering option allows an end-user 105 to filter the entries based on the advertisers 130 type of business or organization. To accomplish this, each advertiser 130 may be associated with one or more business types. For example, the image of the wrench and the shopping cart on entry 420c may indicate that “Advertiser 3” is associated with a business which involves repair and retail, respectively. Thus, an end-user 105 may select the image of a wrench in order to filter the listing to only include advertisers 130 that are associated with the repair business. The end-user 105 could filter the listing in a similar manner using the “Category” filter located in the search portion 410. Regardless of which filtering option is selected, the subset of entries displayed in the listing may be ordered in the same manner as described above.

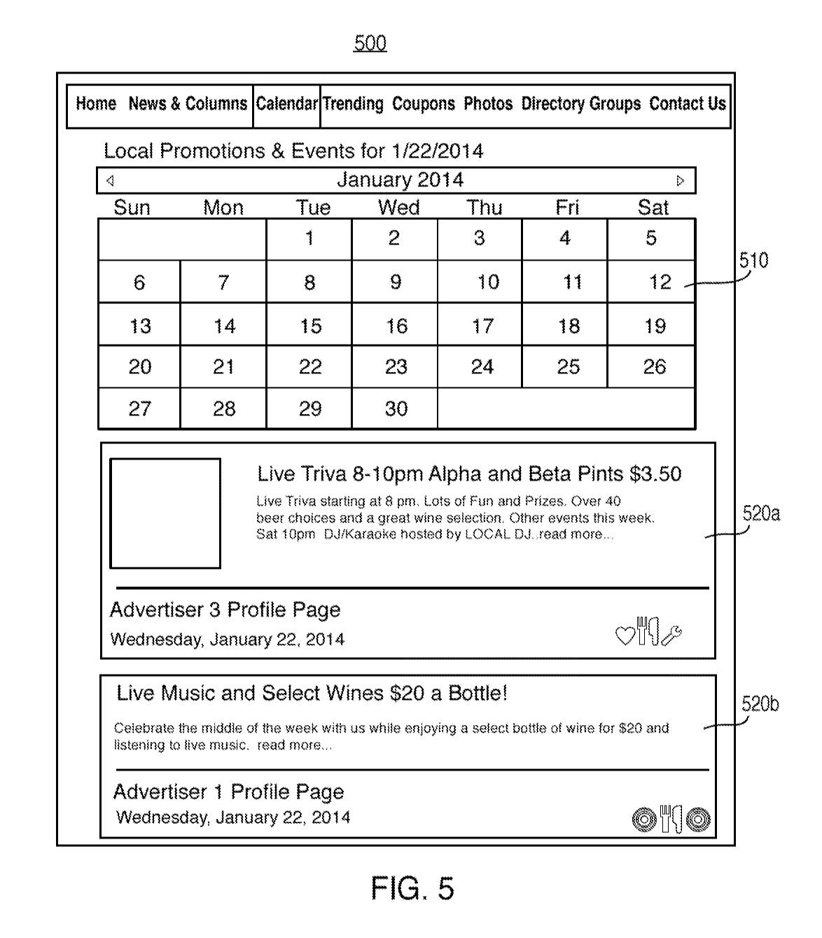

FIG. 5 is an exemplary event and promotion calendar interface 500 that provides a listing of events and promotions that are being offered by the advertisers 130. An end-user 105 may select a particular day on the event and promotion calendar 510 and the listing located beneath the calendar may display events or promotions that are being offered by the advertisers on the selected day. An end-user 105 may scroll down to view additional entries. The information used to populate the entries 520a and 520b in the listing may correspond to the profile information that is used to populate the events section 340 of the advertisers' homepages. An end-user 105 may select a hyperlink associated with an entry in the listing to access more detailed information about an event or promotion, or to navigate to the homepage interface 300 of the advertiser 130 offering the promotion.

An end-user 105 may once again select filtering options associated with a business type of the advertisers 130. For example, if the end-user 105 selects the logo or image associated with the knife and fork (located near the bottom, right portion of entry 520a), then the listing may only display entries associated with restaurants. Regardless of whether or not the listing is filtered, the entries in the listing may be ordered as described above.

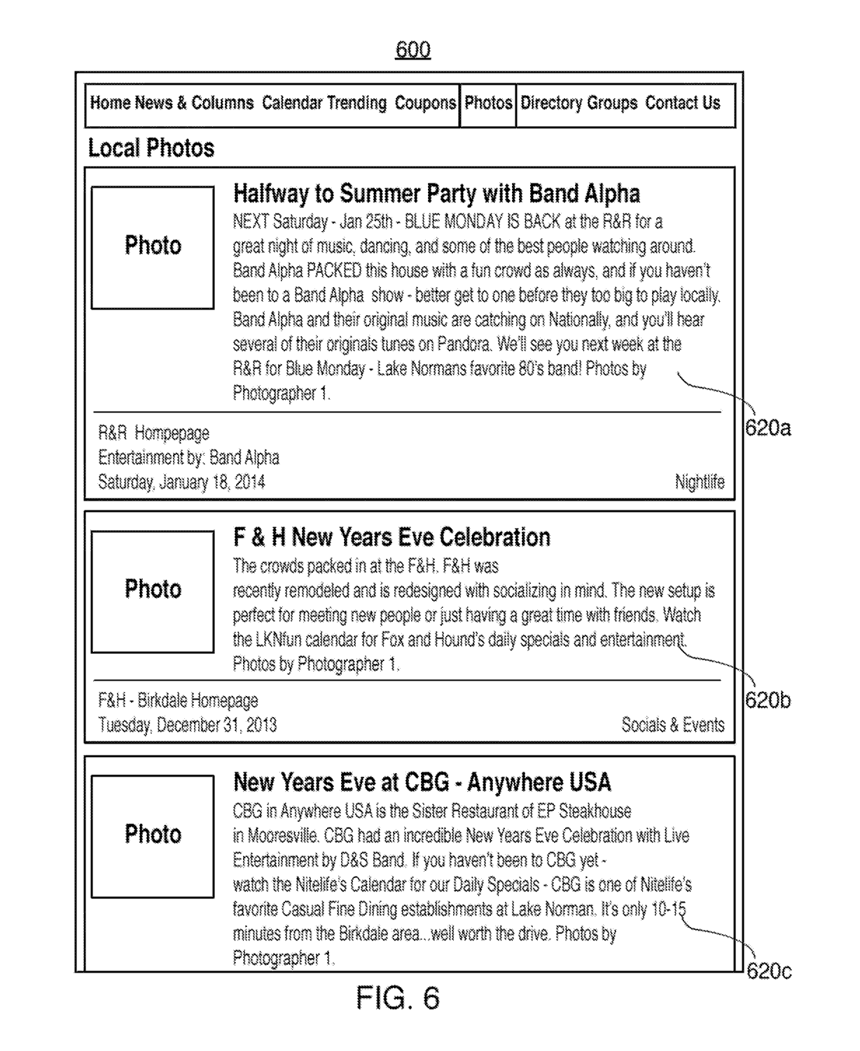

FIG. 6 is an exemplary photo album interface 600 that displays a listing of photo albums associated with the advertisers 130. The information used to populate the entries 620a, 620b and 620c may correspond to the information contained in the photo album section 330 of the advertisers' 130 homepages. Each entry may include a date (e.g., indicating when the album was created or when the event took place), a title of the photo album, a company name for the advertiser 130 associated with the photo album and a description of the company and/or photo album. An end-user 105 may select links associated with the entries 620a, 620b and 620c in order to view the associated photo albums or advertiser homepages.

Each entry in the listing also includes a filtering option that permits an end-user 105 to filter the entries based on the different labels assigned to the photo albums (e.g., nightlife, socials and events, most clicked, boating party or other label that was created for an album). By selecting one of the labels (e.g., “nightlife”) associated with the filtering option, the listing would only display entries that have been tagged with that label. Once again, any listing displayed on the photo album interface 600 may be ordered in the same manner as described above.

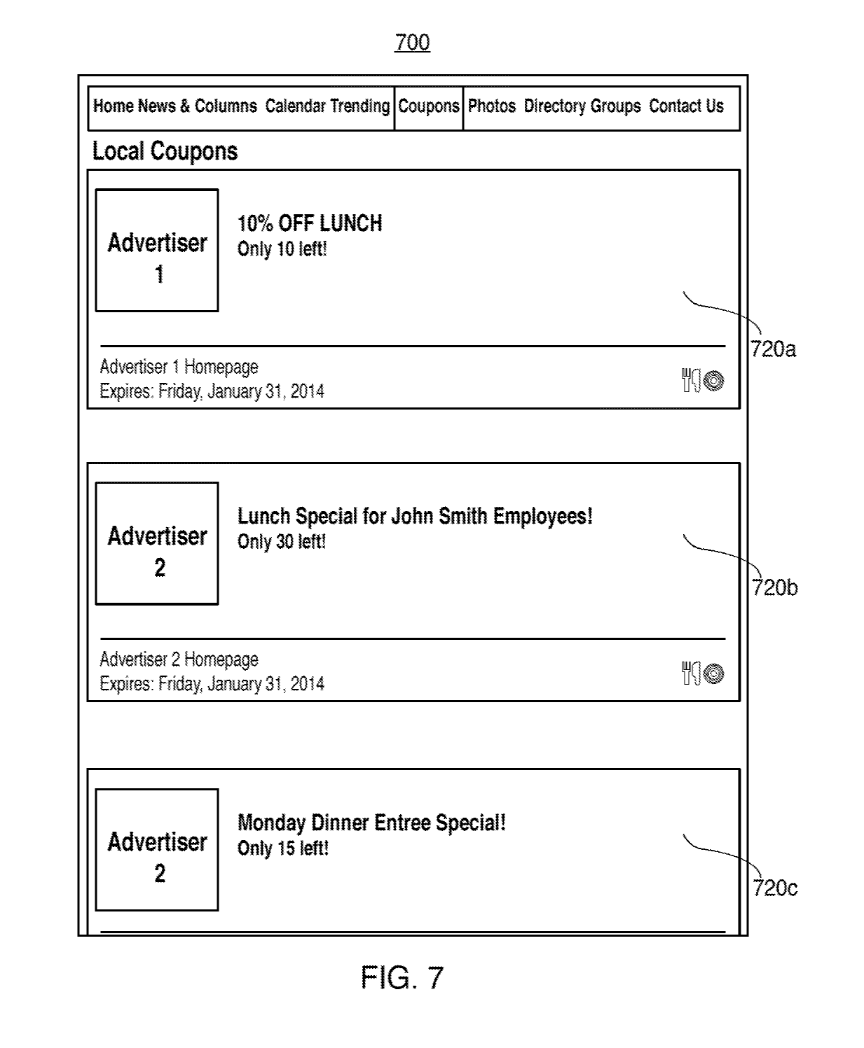

FIG. 7 is an exemplary coupon interface 700 that displays a listing of coupons being offered by the advertisers 130. The information used to populate the entries 720a, 720b and 720c may correspond to the information contained in the coupons section 320 of the advertisers' 130 homepages. Each entry may include dates that indicate when the coupon begins and expires, a title of the coupon or sales promotion, a company name for the advertiser 130 offering the coupon and a description of the company and/or coupon. A user may select links associated with the entries 720a, 720b and 720c in order to view additional details about the coupons, download the coupons, print the coupons or to access advertiser homepages associated with the coupons. An end-user 105 may select the filtering option located in the bottom right portion of an entry in the listing to filter the coupons based on the types of businesses associated with the advertisers 130. Once again, the listing of entries may be ordered in the same manner as described above.

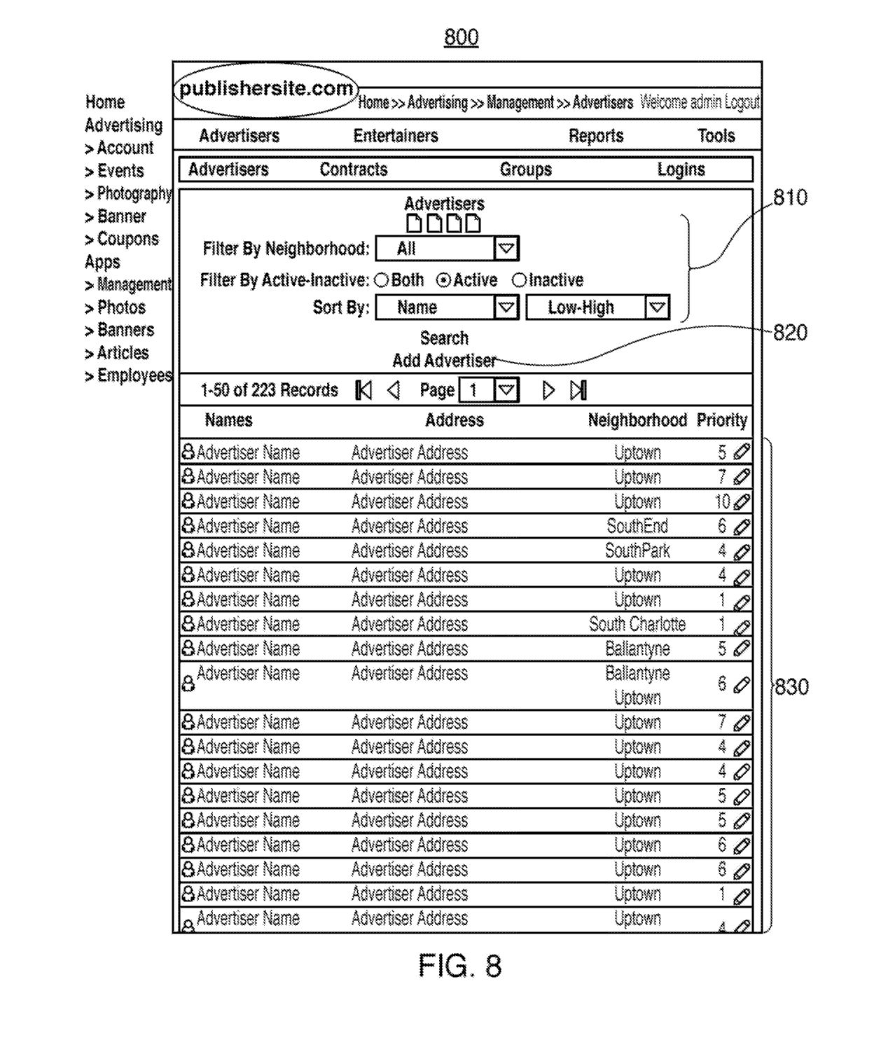

FIGS. 8-21 illustrate exemplary interfaces that may be made available to publisher personnel 125, advertisers 130 or other individuals via the back-end portion of the publications 160. These interfaces may be configured to perform various functions that assist with the management of the advertiser marketplace 170, advertisers 130 and associated data. While many of these interfaces may be intended to be used by publisher personnel 125, it should be recognized that similar interfaces may be made accessible to advertisers 130 in many cases (e.g., via the advertiser accounts associated with each publication 160 and which are accessible via the online publishing platform 150) in order to provide the advertisers 130 with similar functionality.

FIG. 8 is an exemplary interface 800 for managing advertiser accounts. The interface 800 may include a listing 830 of advertisers 130. Each entry in the listing 830 includes the name, address and neighborhood of the advertiser 130. Each entry also includes the priority ranking of the advertiser 130 associated with the entry. As explained above, the advertiser marketplace 170 may use these priority rankings to determine how listings displayed on the interfaces associated with the advertiser marketplace 170 may be sorted or ordered. Publisher personnel 125 or other individuals may select an entry in the listing 830 in order to edit any of the values associated with the entry, as well as other data (e.g., advertiser content) associated with the advertisers 130. Additional entries and corresponding accounts may be created for advertisers 130 by selecting the add advertiser button 820.

The search portion 810 of the interface 800 includes different filtering options that permit the entries to be filtered or sorted. For example, the filtering options may permit the entries in the listing 830 to be filtered based on the neighborhood of the advertisers 130 and the name of the advertisers 130. The entries may also be filtered based on whether the accounts are “active” or “inactive.” An active account represents an account that is in good standing, while an inactive account represents an account that is not in good standing. The status of an account may be rendered inactive for a number of different reasons. For example, an account may be rendered inactive if an advertiser 130 does not pay money owed to the publishing company 120, if the advertiser 130 has gone out of business, if the relationship between the advertiser 130 and publisher 120 has been terminated, if all contracts between the advertiser 130 and publisher 120 have expired or for other similar reasons. In certain embodiments, the advertiser marketplace 170 may only display advertiser content to end-users 105 if the account associated with the advertiser content is active. The publisher personnel 125 may easily render an account inactive (or active) by selecting an option made available via the back-end portion of the publication 120. In response to an account being rendered inactive, the advertiser's 130 information (or a portion thereof) may be removed from the front-end of the publication 120, but all of the advertiser's 130 data may be remain intact in a database stored on the server 140. This permits the advertiser's 130 account to easily be restored to an active status at a subsequent point in time without requiring the advertiser's information to be re-entered.

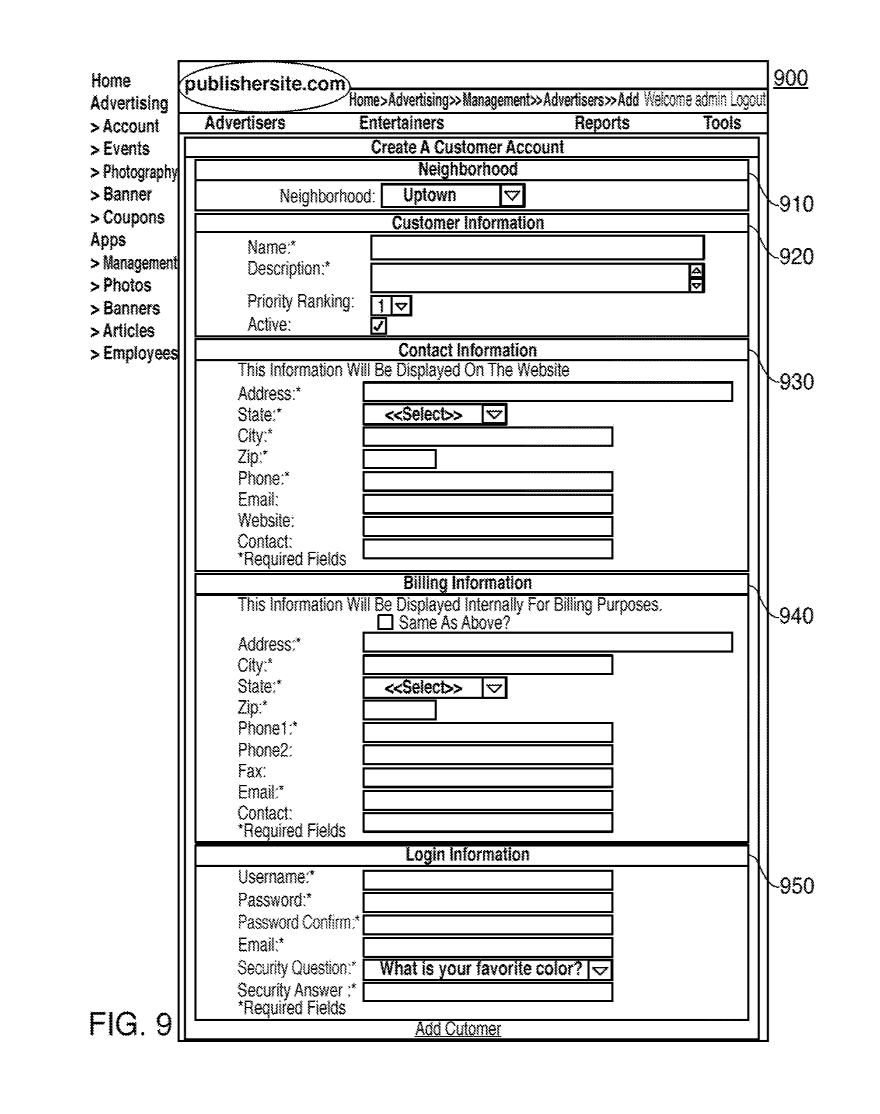

FIG. 9 is an exemplary interface 900 for creating an advertiser account. This interface 900 may be displayed in response to the selection of the add advertiser button 820 shown in FIG. 8. Any information input via this interface 900 may be stored by the publishing platform 150 and associated with the profile that is created for an advertiser 130.

The interface 900 includes a contact information section 930, a billing information section 940 and a login information section 950. The contact information section 930 includes an input form that permits contact information (e.g., company name, address, e-mail address and website) to be input for the advertiser 130 for which the account is being created. The information provided in this section may be displayed to end-users 105 by the advertiser marketplace 170 (e.g., on a homepage interface 300 associated with an advertiser). The billing information section 940 includes an input form that allows billing information associated with the advertiser 130 to be provided. The billing information may be used to pay the publisher 120 for marketing activities. The login information section 950 includes an input form that permits login information to be specified for an advertiser account. The advertiser 130 may use this information to access an account with a publication 160.

The interface 900 further includes a neighborhood information section 920 that allows the neighborhood of the advertiser 130 to be specified. As mentioned above, a publication 160 hosted by the online publishing platform 150 may represent a local publication that is directed primarily to end-users 105 who are located in a specific geographic area. The neighborhood identified by the neighborhood information section 920 may represent a particular area within the geographic area that is associated with the publication 160.

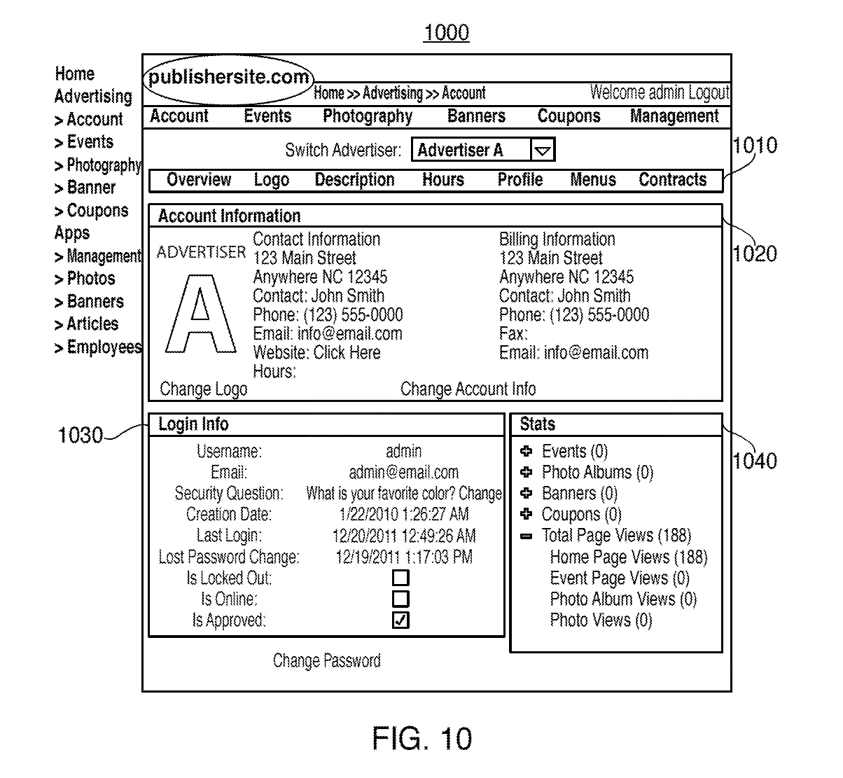

FIG. 10 is an exemplary interface 1000 for viewing and editing an advertiser account. A drop-down menu located at the top of the interface 1000 provides a listing of the advertisers 130 and allows an advertiser 130 to be selected. The information displayed on the interface provides an overview of the selected advertiser's 130 profile. Options included on a menu 1010 allow additional information associated with the advertiser (e.g., hours of operation, description for directory listing, menus and contracts) to be viewed and updated.

An account information section 1020 displays the contact and billing information, as well as a logo, for the selected advertiser 130. A login information section 1030 displays the login information (e.g., username, password and security question) for the advertiser 130. This section 1030 also displays the start date for the advertiser 130 indicating when the account was created. As explained above, this date may be used, at least in part, to order the entries in the listings displayed via the advertiser marketplace 170.

A statistics section 1040 provides a statistical overview indicating how end-users have viewed and interacted with (e.g., clicked-on, selected or downloaded) advertiser content via the advertiser marketplace 170. As explained above, FIG. 3 illustrates an exemplary profile for an advertiser and FIGS. 4-7 illustrate exemplary interfaces that display aggregated advertiser content associated with the advertisers 130. In addition to providing the interfaces which provide the aggregated information, the advertiser marketplace 170 may also provide similar interfaces that are specific to each advertiser 170. For example, an event and promotion calendar interface may be provided which only includes information and events related to a specific advertiser 130. Likewise, a coupon interface and photo album interface may be displayed which only include coupons and photo albums for a specific advertiser 130. The statistics section 1040 may provide any statistics related to the end-users 105 viewing or interacting with either the interfaces displaying the aggregated advertiser content or the interfaces which are specific to the advertisers 130. Exemplary statistics may indicate the number of times that an end-user 105 viewed or interacted with an advertiser's 130 homepage, coupons, photo albums, event and promotion calendar or directory listing.

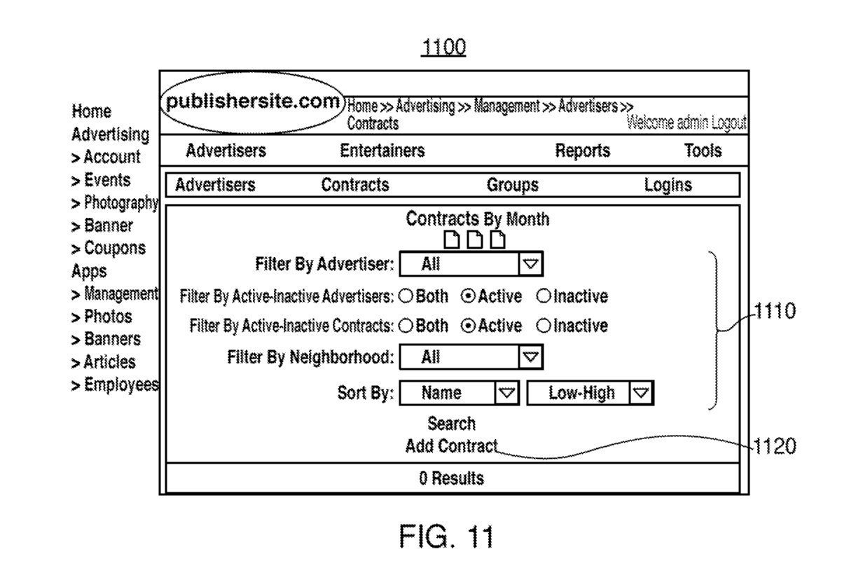

FIG. 11 is an exemplary interface 1100 for managing contracts associated with advertiser accounts. Each advertiser 130 may enter into one or more contracts with a publisher 120 that provides a publication 160 that is hosted on the online publishing platform 150. The contracts may determine the scope of the marketing campaign for the advertiser 130. In certain embodiments, an advertiser 130 may execute a new contract each time the advertiser 130 engages in a new marketing activity (e.g., selects an advertising plan, requests a featured advertisement to be displayed or requests a banner to be displayed).

The interface 1100 includes a filtering form 1110 and a button 1120 for adding new contracts. The filtering form 1110 includes various options for filtering the contracts for the advertisers 130. The interface may display a listing of contracts (not shown) that satisfy the filtering criteria beneath the filtering form 1110. It should be noted that in this exemplary interface 1100 there are no contracts displayed. However, if there were contracts that satisfied the filtering criteria selected in the filtering form 1110, they may be listed as entries beneath the filtering form 1020. The entries associated with the contracts may then be selected to permit publishing personnel 125 and/or advertisers 130 to view, modify or terminate the contracts.

For example, a first filtering option may permit all contracts for all advertisers to be displayed or to permit the selection of specific advertisers 130. A second filtering option permits contracts to be filtered based on whether the advertisers 130 have active or inactive accounts. A third filtering option permits the contracts to be filtered based on whether the contracts are active or inactive. An active contract may represent a contract that covers an existing and on-going relationship between the publisher 120 and the advertiser 130, while an inactive contract may represent a contract that does not govern an existing relationship between the publisher 120 and the advertiser 130 (e.g., because the contract expired or was terminated). Additional filtering options may permit the contracts to be filtered based on the neighborhood of the advertisers 130 and other criteria. The filtering form 1110 may also provide options for sorting any entries displayed in the listing of contracts.

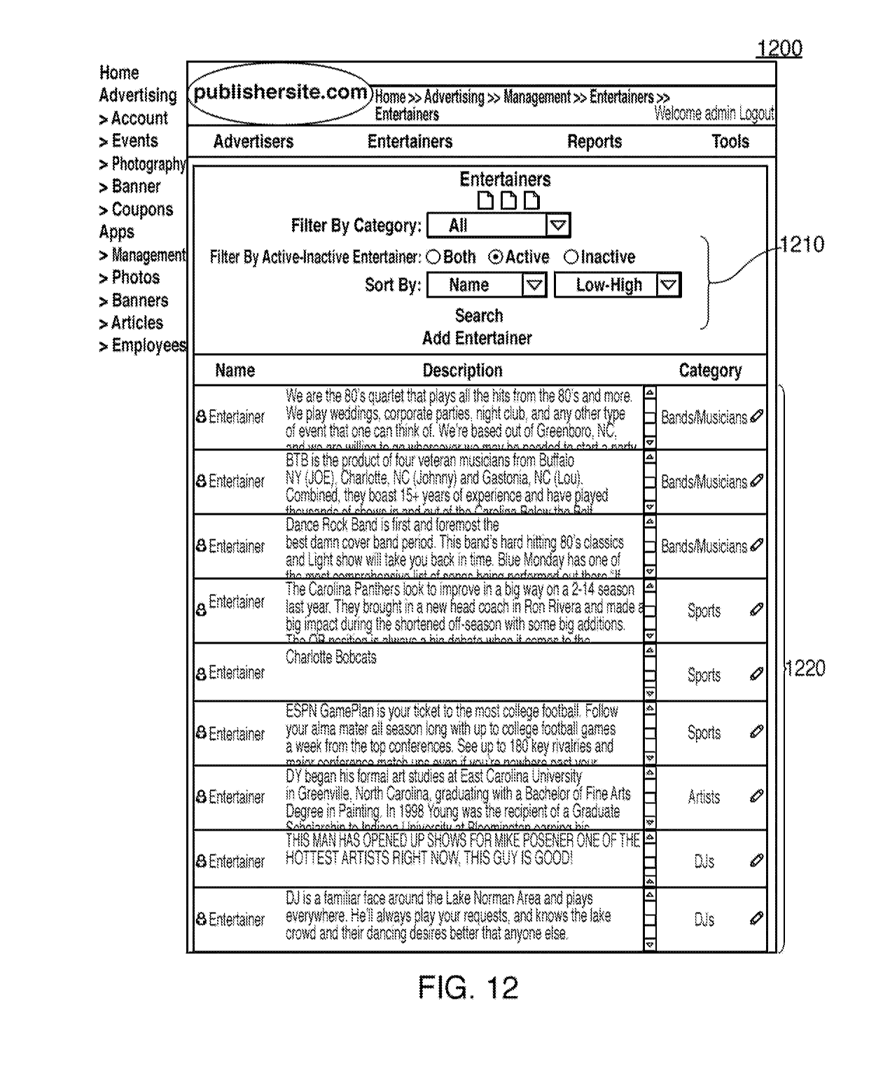

FIG. 12 is an exemplary interface 1200 for managing entertainers. As explained above, the advertisers 130 may host or sponsor events (e.g., which may be displayed on an event and promotion calendar provided by the advertiser marketplace 170) and the advertisers 130 may hire or use entertainers (e.g., musicians, artists, magicians, disc jockeys, etc.) at these events. The online publishing platform 150 may assist the advertisers 130 with the task of finding, selecting and scheduling the entertainers for these events. In certain embodiments, crowd sourcing features may be utilized to accomplish this. For example, the publisher personnel 125 or entertainers themselves may setup accounts for the entertainers. Each entertainer account may be associated with a profile for the entertainer that identifies an associated entertainer's name, address, category of entertainment (e.g., indicating that the entertainer is a musician or disc jockey), contact information (e.g., e-mail address and phone number), description and other relevant information.

Publisher personnel 125, advertisers 130 or other individuals may utilize the interface 1200 in FIG. 12 to search the entertainer account information, identify potential entertainers for an event and send requests to a plurality of entertainers for attending the event. The requests may be sent to an e-mail address associated with the information in the entertainers' profiles or may be sent to inboxes associated with the entertainers' accounts. The requests may include information about the event and the associated advertiser 130 (e.g., company name, event location and event time). The entertainers may respond and indicate their availability for a particular event. The publisher personnel and/or advertisers 130 may then schedule an entertainer for the event.

The interface 1200 includes also a listing of entertainers 1220 and a filtering form 1210 that permits the entries in the listing 1220 to be filtered. For example, the filtering form 1210 may allow the entries to be filtered based on the category of entertainment provided by the entertainers and/or based on whether the entertainer accounts associated with the entertainers are active or inactive. Once again, an active entertainer account may represent an account that is in good standing (e.g., all fees have been paid to the publisher 120 and the entertainer is still providing entertainment services), while an inactive entertainer account may represent an account that is not in good standing (e.g., because of failure or inability to pay fees or because the entertainer has gone out of business). The bottom of the filtering form 1210 also includes a button or option for adding a new entertainer account.

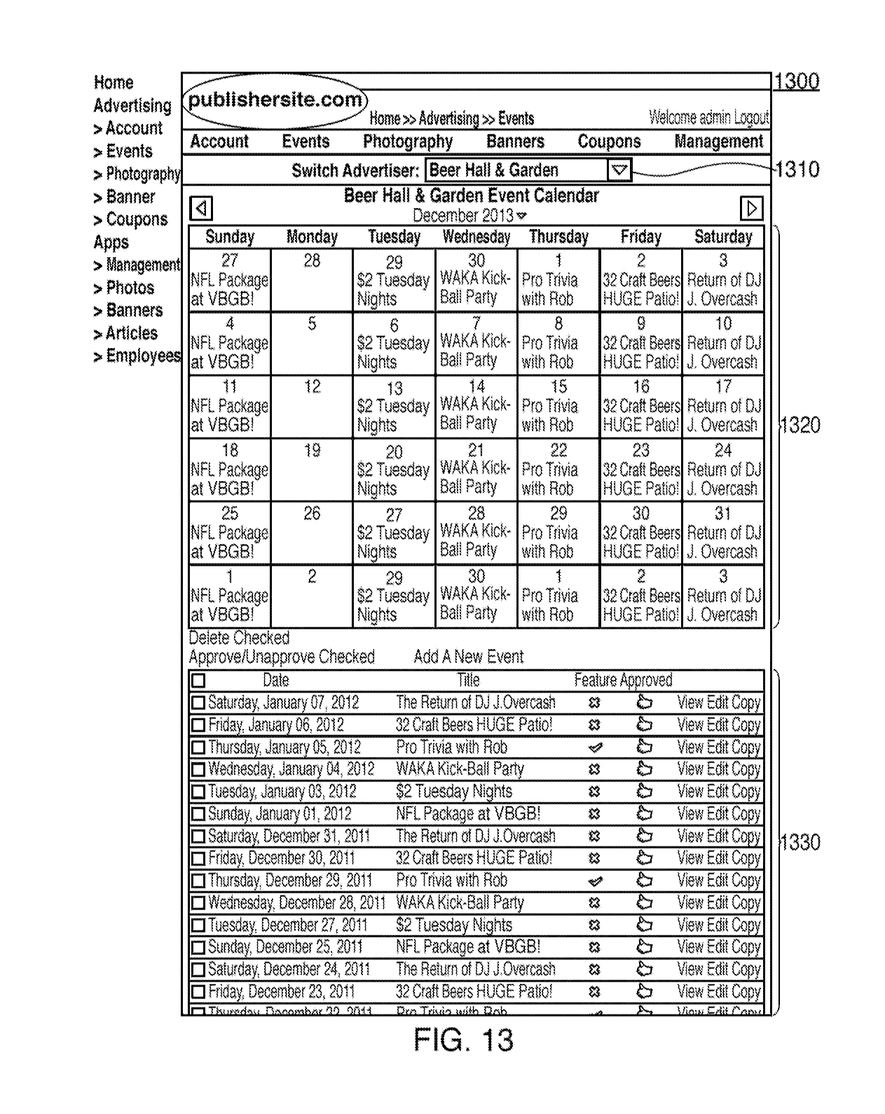

FIG. 13 is an interface 1300 for managing an event and promotion calendar for a selected advertiser 130 in accordance with certain embodiments of the present invention. The interface 1300 includes an advertiser input element 1310 for selecting an advertiser 130. Beneath the advertiser input element 1310 are options that permit a particular month to be selected. A calendar portion 1320 displays the names of events and promotions for the selected advertiser 130 that are scheduled to take place during the selected month. A listing of events 1330 that have been created for the advertiser 1330 is provided below the calendar portion 1320. Selection of an entry in the listing 1330 permits the publisher personnel 125, advertisers 130 or other individuals to view a detailed description of the event, edit the event details, copy the event or delete the event. An option above the listing permits additional events to be created.

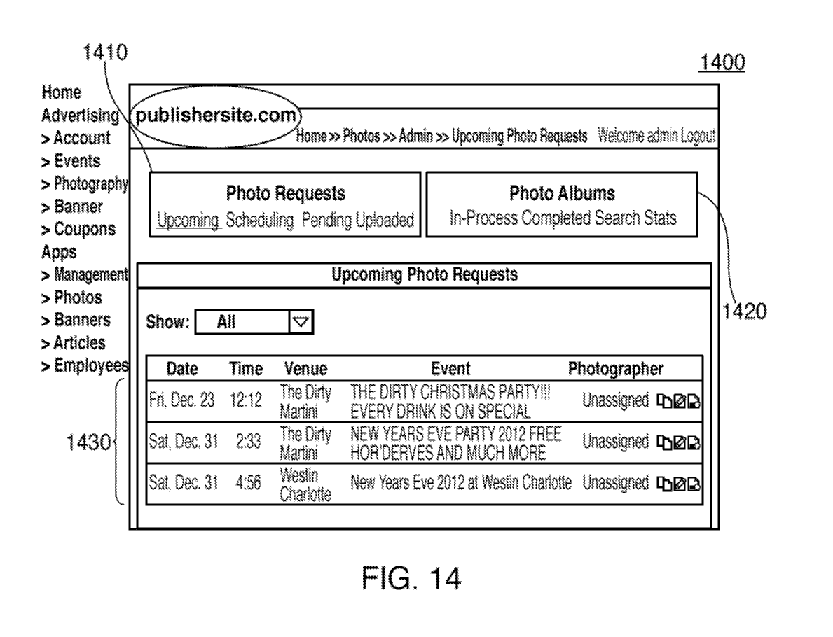

FIGS. 14-17 illustrate exemplary interfaces that may be used to process photography requests received from advertisers 130, schedule photographers to fulfill the requests and manage the creation of photo albums. As explained below, crowd sourcing features permit advertisers 130 to easily schedule photographers for events. More specifically, FIG. 14 is an exemplary interface 1400 for displaying upcoming photography requests. The interface 1400 includes a photo request management menu 1410 that includes links (i.e., “Upcoming,” “Scheduling,” “Pending” and “Uploaded”) to various interfaces for managing the fulfillment of photo requests. The interface 1400 also includes a photo album management menu 1420 that includes links (i.e., “In-Process,”“Completed,” “Search” and “Stats”) to various interfaces for managing the creation of a photo album.

In certain embodiments, advertisers 130 may submit photography requests via their accounts associated with the publications 160. For example, an advertiser 130 may login to their account and submit a request for assistance in scheduling a photographer for an event. The request may include details about the event (e.g., name, time and location of the event) for which a photographer is needed. The advertisers 130 can submit requests in other ways as well (e.g., by placing a telephone call or sending an e-mail to publisher personnel 125). The requests submitted by the advertisers 130 may appear in a listing of photography requests 1430. Publisher personnel 125 or other individuals may select entries in the listing 1430 to view additional details about the request or associated event, and to schedule a photographer for the advertisers 130.

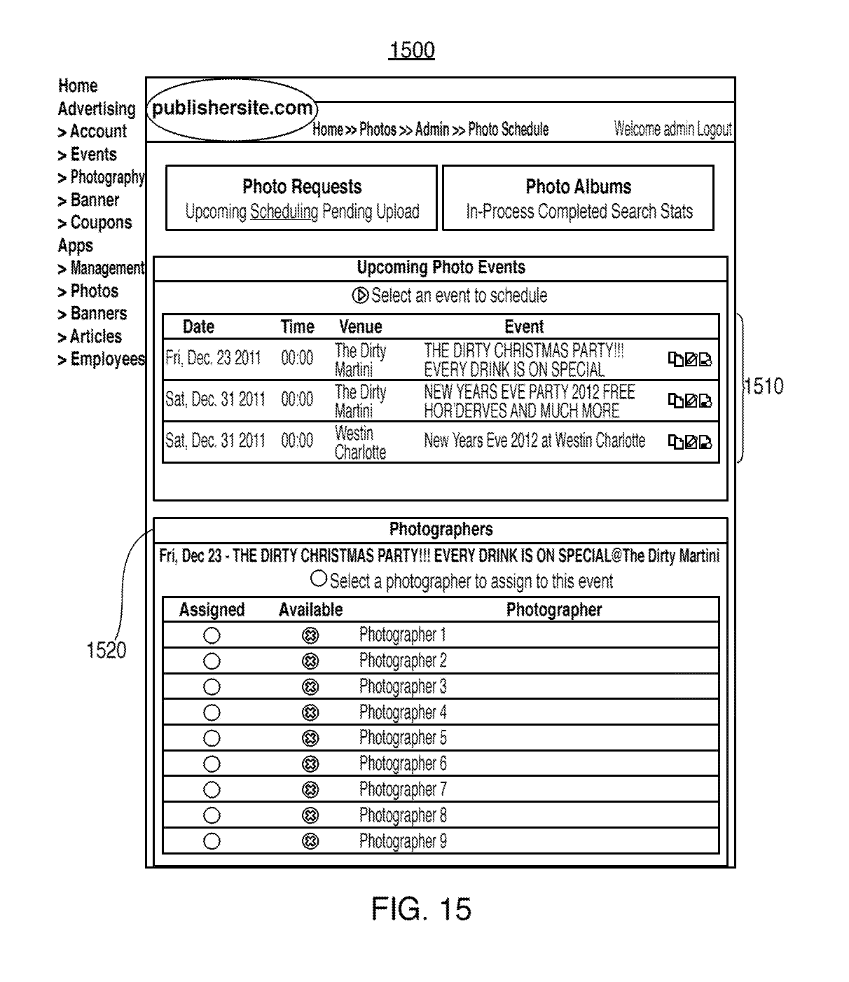

FIG. 15 is an exemplary interface 1500 for assigning photographers to photography requests. The interface 1500 includes a listing of upcoming photography requests 1510 and a listing of photographers 1520. Publisher personnel 125 or other individuals may select an entry in the listing of upcoming photography requests 1510 and assign one or more of the photographers identified in the listing of photographers 1520 to fulfill the requests.

In certain embodiments, selecting the photographers to fulfill a photography request may include sending separate invitations to a plurality of photographers to determine which photographers are available to fulfill the requests. Feedback may be received from the selected photographers (e.g., via e-mail) that indicates whether or not they are available to fulfill the photography requests. One or more of the photographers who indicated that they are available to fulfill a request may then be assigned to the request. After the requests are fulfilled, the photographers may login to the back-end portion of the publication 160 and upload the photographs to the publishing server 140.

The photographs may be utilized to create photo albums for the advertisers 130 which can be made accessible to end-users 105 via the advertiser marketplace 170. In certain embodiments, similar techniques and interfaces may be utilized to assign photographers to cover news events. For example, in the case of a breaking news story, publisher personnel 125 may transmit invitations to a plurality of photographers to cover the event. The photographers may provide feedback which indicates whether they are available to cover the news event and the publisher personnel 125 may assign one or more of the available photographers to cover the event. The photographer may then upload the photographs to the publishing server 140 and the publisher personnel 125 may select one or more of the photographs to be included in an article 165 for the publication 160. Similar techniques may also be utilized to select entertainers for events, or to select graphic designers and authors for the creation of an article 165.

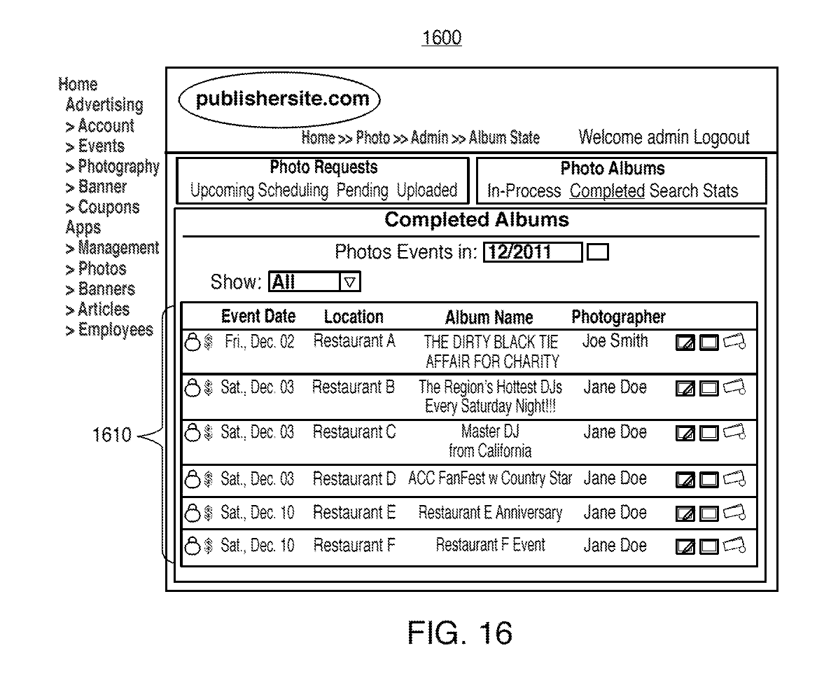

FIG. 16 is an exemplary interface 1600 configured to display a listing of completed photo albums. As explained above, photographers may be assigned to fulfill photography requests and the photographers may upload photographs to the publishing server 140 to create photo albums (or articles for the publication 160) for the advertisers 130. Thus, the interface 1600 displays a listing of photo albums 1610 that have been completed for the advertisers 130. It should be noted that the photo albums included in the listing do not only include photo albums that were created using the assistance of photographers. For example, in some cases, the advertisers 130 or publishing personnel 125 may upload photographs to the server 140 (e.g., by selecting existing photographs stored on a local computer or on a social media website) to create the photo albums.

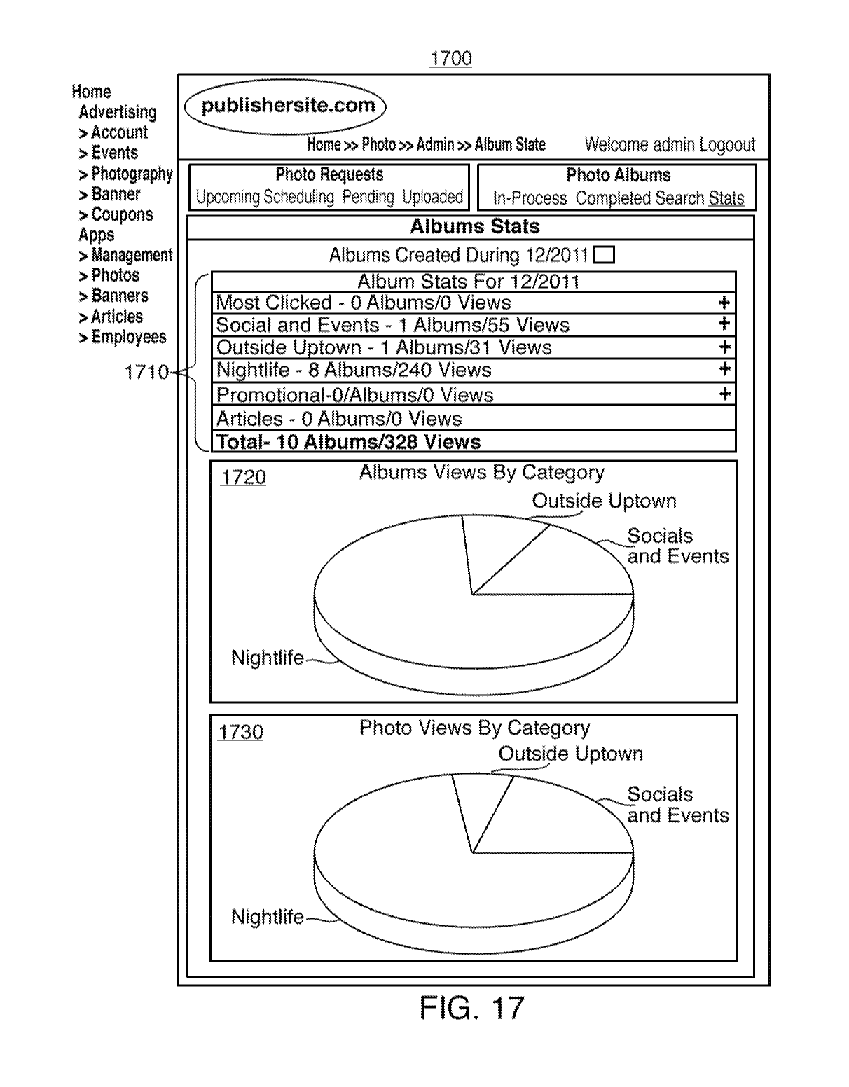

FIG. 17 is an exemplary interface 1700 for displaying statistics associated with the completed photo albums. The interface 1700 includes a statistics summary section 1710 that summarizes how end-users 105 have viewed or interacted with the photo albums that are made available via the advertiser marketplace 170. For example, the statistics summary section 1710 organizes the albums into different categories (e.g., “Nightlife” and “Most Clicked”) and indicates how many times an end-user 105 has viewed the photo albums or photographs associated with each category. Each entry in the statistics summary section 1710 may be selected to show a more detailed explanation of the statistical breakdown. A first chart portion 1720 and second chart portion 1730 may provide pie charts (or other types of charts or graphs) that provide a visual summary of the statistics associated with the photo albums.

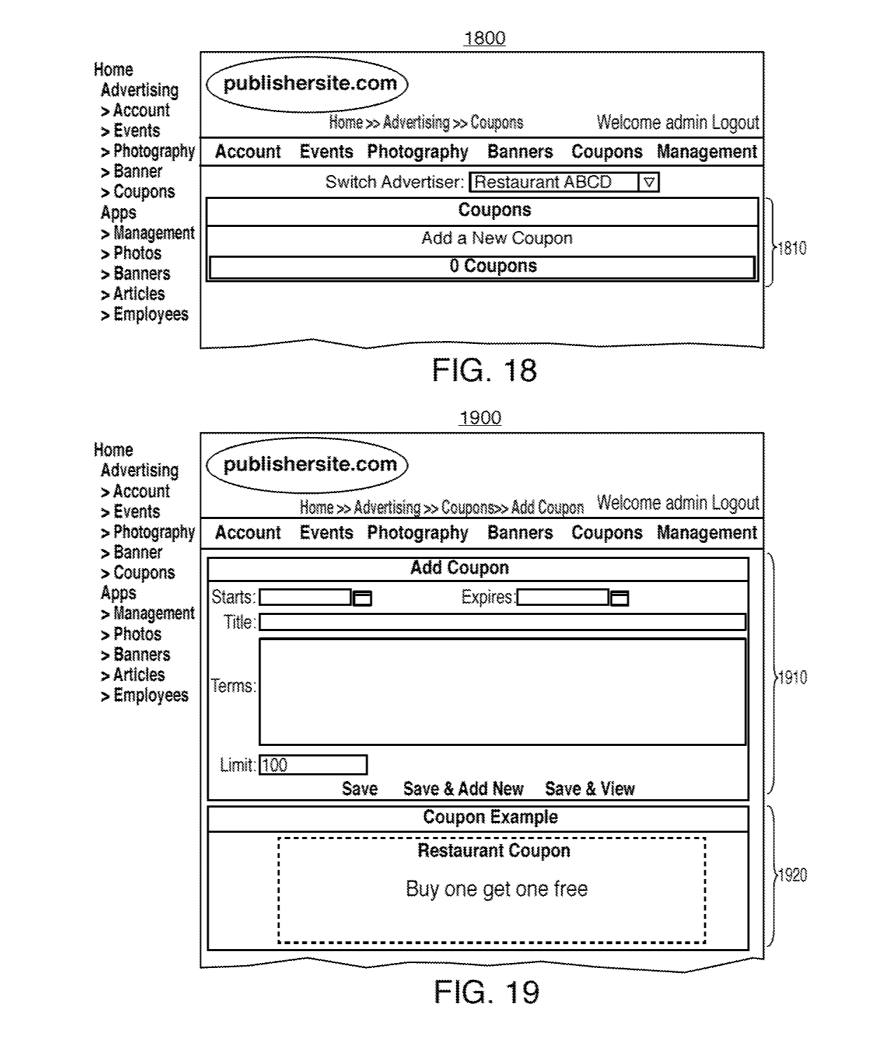

FIG. 18 is an exemplary interface 1800 for managing coupons for a selected advertiser 130. The top portion of the interface 1800 includes an input element for selecting an advertiser 130. The interface 1800 also includes a coupon listing section 1810 that provides a listing of coupons that have been created for the selected advertiser 130. The “Add Coupon” element may be selected to create a new coupon. In this example, no coupons have been created for the selected advertiser 130. However, in the case that one or more coupons had been created for the selected advertiser 130, the listing of the coupons 1810 would include separate entries that correspond to the coupons and the entries could then be selected in order to permit the coupons to be edited, updated or deleted.

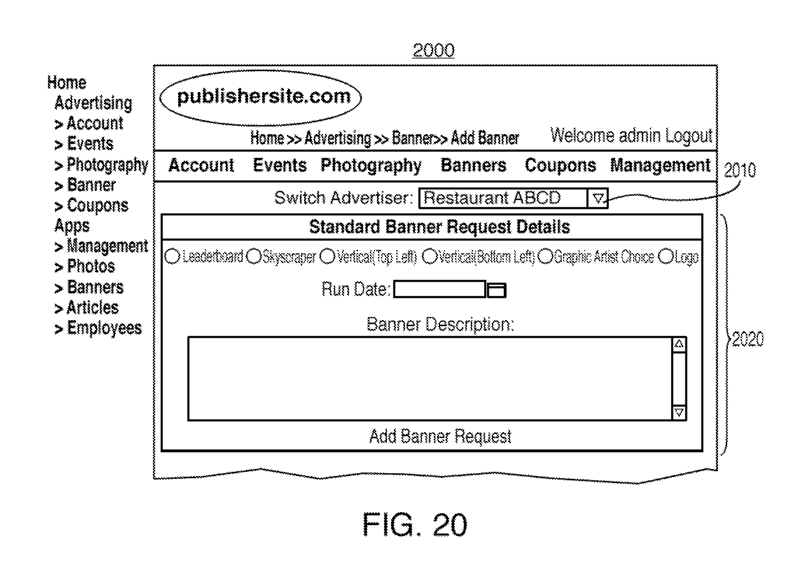

FIG. 19 is an exemplary interface 1900 for adding a new coupon for a selected advertiser 130. The interface includes a coupon input form 1910 that permits information associated with the coupon to be specified. For example, an individual creating a coupon may specify a coupon title, start and expiration dates, terms and conditions associated with redeeming the coupon and a number indicating how many of the coupons may be made available, offered or redeemed. The coupon simulation section 1920 may demonstrate how the coupon being created will appear when it is made available to end-users 105 via the advertiser marketplace 170.

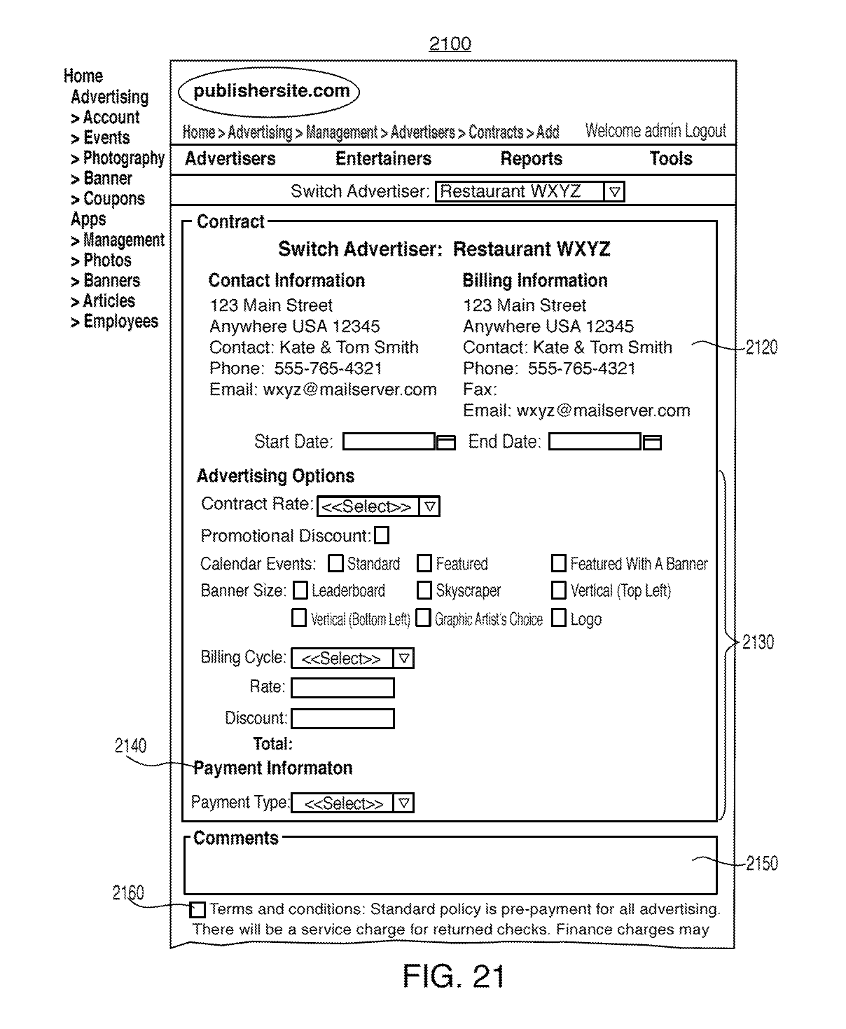

FIG. 20 is an exemplary interface 2000 for submitting a banner request. In general, a banner request is a request to display an advertisement to end-users 105 via the front-end portion of a publication 160. A banner is not required to appear on one of the interfaces associated with the advertiser marketplace 170. For example, the banner may be displayed on a homepage of the publication 160 or on interfaces that display articles for the publication 160 (e.g., in the right hand margin of an interface).

An advertiser selection element 2010 permits an advertiser 130 to be selected. A banner request creation form 2200 permits details pertaining to the banner request to be specified. For example, the form 2200 may permit an individual to provide a description of the banner, upload images for the banner, select the location and size of the banner, and specify the run dates for the banner.

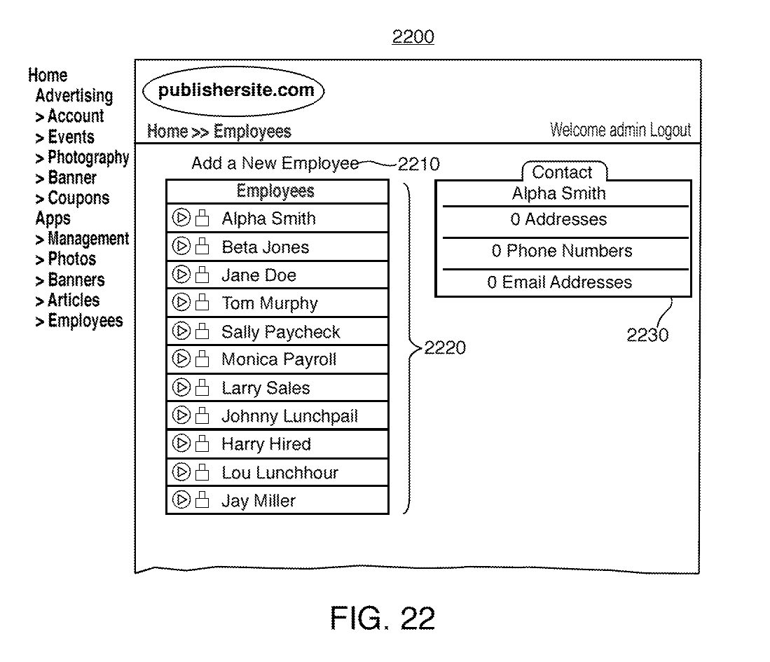

FIG. 21 is an exemplary interface 2100 for creating a contract between an advertiser 130 and a publisher 120. As explained above, the contracts may be used to define relationships between the advertisers 130 and the publishers 120 with respect to advertising via a publication 160 provided by the publisher 120. For example, the contracts may define relationships relating to advertising plans, banners, featured advertisements and other related items. The interface 2100 includes an advertiser information section 2120 that displays the contact and billing information for a selected advertiser 130. An advertising options section 2130 permits the selection of different types of advertising options 2130. In this exemplary contract, the options may include options for purchasing banners and featured advertisements. Billing options may also be specified. A payment section 2140 may provide options for indicating how payment will be made by the advertiser 2140. A comments section 2150 may allow entry of additional comments relating to the contract or relationship between the advertiser 120 and publisher 130. A terms and conditions section 2160 may specify specific terms and conditions that apply to the relationship between the advertiser 130 and publisher 120.

In certain embodiments, the publisher personnel 125 may also access an interface that allows for the management of contracts for the advertisers 130. In particular, the interface may include a window that shows all of the contracts that are pending for the current month (or other time period of time). This window may indicate which advertiser's 130 are “up to date” with respect to providing information for display via the advertiser marketplace 170 and which advertisers 130 should be notified to provide updated or additional information. For example, the window may indicate how many events are posted for each advertiser on their event and promotion calendar for the month, how many coupons are being offered by the advertiser 130 for the current month, and whether the advertisers 130 have used featured advertisers that were purchased. Notifications may be sent to the advertisers 130 that should update their information for the month or time period or which should use the featured advertisers before they expire. The interface may also include a window that identifies contracts that are about to expire. This allows the publisher personnel 125 to easily identify those advertisers 130 that need to renew contracts and to send notifications to those advertisers 130.

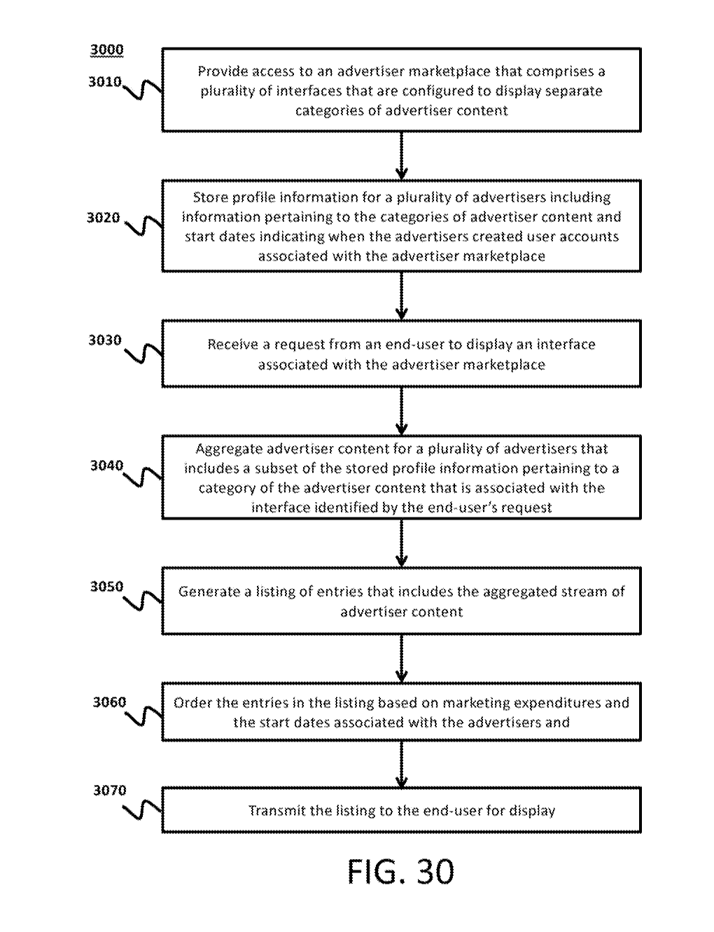

FIG. 30 is a flow chart of a method 3000 for providing an advertiser marketplace 170 in accordance with certain embodiments of the present invention. End-users 105 are provided access to an advertiser marketplace 170 that comprises a plurality of interfaces that are configured to display separate categories of advertiser content (step 3010). In certain embodiments, the interfaces may be configured to display advertiser content associated with a directory listing, event and promotion calendar, coupons and photo albums. Profile information is stored for a plurality of advertisers 130 that includes information pertaining to the categories of advertiser content and start dates indicating when the advertisers 130 created user accounts associated with the advertiser marketplace 170 (step 3020). As explained above, the homepage interface 300 illustrated in FIG. 3 displays exemplary profile information that may be associated with the advertisers 130. A request is received from an end-user 105 to display an interface associated with the advertiser marketplace 170 (step 3030). For example, the request may be sent to the publishing server 140 in response to the end-user selecting a hyperlink or navigating to a URL associated with the interface.

Advertiser content associated with a plurality of advertisers is then aggregated (step 3040). The aggregated content includes a subset of the stored profile information which pertains to a category of the advertiser content that is associated with the interface identified by the end-user's request. For example, in response to a user transmitting a request to display the coupon interface 700 illustrated in FIG. 7, the advertiser marketplace 170 may retrieve coupon information that is associated with the profile information of the advertisers 130 and may aggregate the coupon information. A listing of entries is then generated that includes the aggregated stream of advertiser content (step 3050). Staying with the previous example, a listing of coupons may be generated that includes entries for a plurality of coupons. The entries in the listing are ordered based on marketing expenditures and the start dates associated with the advertisers (step 3060). As explained above, purchases associated with featured advertisements may also be taken into consideration in regard to the ordering of the entries. The listing is then transmitted to the end-user 105 for display (step 3070). The end-user 105 can then interact with the entries in the listing (e.g., by viewing, selecting or downloading data associated with the entries).

### III. Exemplary Embodiments for a Reverse Publishing System

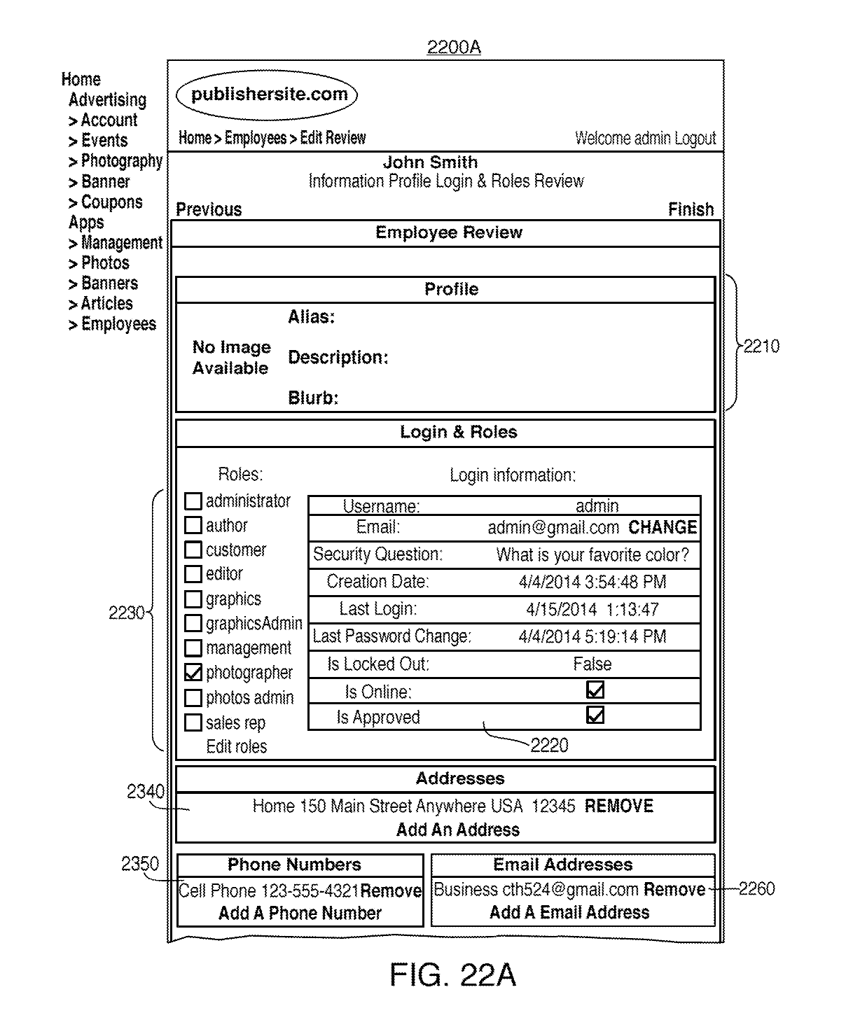

A more detailed description of the reverse publishing system 180 is provided below with reference to FIGS. 22-29. In contrast to traditional publishing systems, the reverse publishing system 180 may be configured to generate articles and other content for digital publications 160, which can thereafter be converted to a format for inclusion in printed publications. The entire process of creating an article 165 may be automated in the cloud. Interfaces and forms provided by the reverse publishing system 180 allow the article content to be created, uploaded, reviewed, edited and updated in a centralized location. The article contributors (e.g., editors, authors and photographers) can access the article content at any time and from any location using a client device 110 and, therefore, are not required to be located in the same physical or geographic location in order to effectively collaborate during the creation process. Once finalized, the article 165 can be instantly published via a digital publication 160 and/or converted to a format for inclusion in a printed publication. In addition to publishing articles 165, the reverse publishing system can also be utilized to reverse publish coupons and information included on event and promotion calendars. In doing so, the publisher personnel 125 may define or specify a subset of the coupon or calendar information that is to be output for print (e.g., based on a category or label assigned to the coupons or events, or based on the locations of the advertisers associated with the coupons or events).

Initially, the publisher personnel 125 working for a publisher 120 may be assigned roles associated with their involvement with the article creation process. For example, profiles may be setup for the publisher personnel 125 that include data indicating one or more roles that are assigned to each individual. Exemplary roles may include roles associated with editors, authors, photographers, graphic designers, administrators or other individuals that perform services associated with the publishers 120. The reverse publishing system 180 may utilize the roles in a variety of different ways to control the workflow associated with creating an article for a publication 160.

The roles may be used to determine who receives a variety of different requests (e.g., requests to create a new article, requests to review article drafts, requests to provide photographs and other content for the article, etc.). Throughout the various stages of the workflow process, the roles may also be used to determine how article assignments are allocated, who has access to the content associated with the article, who has authority to edit the article content, who has the authority to review drafts and content associated with the article, and who has the authority to approve or deny article content. The roles may be used for many other purposes as well.

In certain embodiments, the reverse publishing system 180 may automatically send notifications and requests to the publisher personnel 125 at various times during the article creation process to notify certain individuals that feedback is needed or requested. For example, an author may initiate a request to create a new article 165 and the request may automatically be transmitted to an editor for review. Similarly, after an author finalizes a draft of an article 165, the notification may be sent to an editor to review the article 165. The requests and notifications may be transmitted to inboxes in the user accounts associated with the publisher personnel 125 (e.g., which may be accessible to the publisher personnel 125 via the back-end portion of a publication 160) and/or to e-mail addresses for the publisher personnel 125. All of the data associated with the article will be available via the reverse publishing system 180 and the individuals can login and access the data from any location using a client device 110.

In certain embodiments, the roles assigned to the publisher personnel 125 may be divided generally into two categories. A first category comprises content contributor roles that may be assigned to individuals who are generally responsible for generating the content (e.g., text, photographs or graphics) for the articles 165. These roles may include authors, photographers and graphic designers. A second category comprises editorial roles that may be assigned to individuals who oversee or supervise the article 165 content and layouts created by the content contributors. Depending upon the needs or staffing of a publisher 120, there may be a single editor or there may be multiple editors.

In certain embodiments, the reverse publishing system 180 may permit one or more of the editorial roles to be assigned to the publisher personnel 125. In certain embodiments, an individual assigned an editorial role is given the ultimate authority to make all decisions when it comes to creating an article 165. For example, an individual assigned an editorial role may be given the ultimate decision-making authority with respect to accepting or denying ideas for creating a new article, assigning tasks to individuals during the article creation process (e.g., tasks associated with authoring an article or taking photographs for an article), reviewing and determining the content of an article, selecting the article to be included in a digital or printed publication 160 and other tasks associated with creating or publishing the article 165.

In certain embodiments, several different editorial roles may be assigned. The role of an executive editor may be assigned to an individual who has the ultimate decision-making authority with respect to all matters concerning the creation of the process. Several additional department editors may be assigned roles associated with overseeing or supervising specific categories of content for the articles 165 that are created. More specifically, the role of a content editor may be assigned to an individual that oversees the textual content of an article 165, the role of a photo editor may be assigned to an individual that oversees the photography that is included in the articles, the role of a graphics design editor may be assigned to an individual that oversees the graphics (or artwork and related content) that are included in the articles, and/or the role of a layout design editor may be assigned to an individual that oversees the layout of the articles 165. Each department editor may approve or deny article content that is submitted by the content contributors before submission to the executive editor. The executive director may then review the submissions approved by the department editors and make a final determination as to whether the content for the article 165 is acceptable. Article content that is not deemed acceptable by an editor may be sent back to the content contributors (and/or department editors) in order to be revised.

In certain embodiments, individuals who are assigned editorial roles may utilize the reverse publishing system 180 to assign tasks to the content contributors. This may be accomplished by selecting particular content contributors to complete the tasks (e.g., from a listing of individuals displayed on an interface), or by using crowd sourcing techniques as discussed in further detail below. Regardless of how the tasks are assigned, the content contributors may submit all content via the reverse publishing system 180. For example, an individual assigned the task of authoring an article may utilize forms and other tools provided on interfaces displayed by the reverse publishing system 180 to create the textual content for the article. Likewise, photographers and graphic designers may upload photographs, graphics and other article content for the articles via the reverse publishing system 180. The editors may utilize interfaces provided by the reverse publishing system 180 to edit or revise any of the content and/or to send the content back to content contributors to be revised. All of the content associated with an article may be stored on the publishing server 140 throughout all of the workflow stages.

In certain embodiments, the article content may be made accessible by the cloud-based reverse publishing system 180 to all of the publisher personnel 125. In certain embodiments, the roles assigned to the article contributors may limit access to the article content and/or ability to edit the article content. For example, a graphic designer may not be permitted to access or edit the textual content of an article 165, but an executive editor may be permitted to access and edit the textual content of an article at any point to the creation process. The roles may also be utilized to identify the individuals who are capable of making certain decisions and performing certain functions. For example, individuals assigned the role of a photographer or graphic designer may be permitted to perform functions associated with uploading or providing photographs and graphics, but may not be permitted to incorporate the photographs or graphics into the articles being created or to determine when an article is finalized and ready for publication. In contrast, an individual that was assigned the role of editor may be permitted to perform any function and make any decision with respect to creating, approving and publishing the articles 165.

It should be noted that other types of roles may be assigned to individuals which were not explicitly mentioned or described above. For example, the role of an administrator may be assigned to an individual who performs administrative functions (e.g., creating profiles for the publisher personnel 125, website maintenance and other functions that are not directly related to the article creation process). Likewise, the role of a sales representative may be assigned to individuals who assist advertisers 130 with marketing activities (e.g., recruiting new advertisers 130 or assisting advertisers 130 with inputting advertiser content for display in the advertiser marketplace 170). Even further, other types of content contributor roles are contemplated (e.g., video editors, video camera operators, news anchors or spokespersons, audio recording editors or the like). Other types of roles are also contemplated.

It is also worth noting that individuals may also be assigned more than one role. For example, a single individual may be assigned all editorial roles so that all content and layout information for an article is decided by one person. Likewise, the roles associated with a graphic designer and a graphics editor (as well as a photographer and a photo editor) may be assigned to a single individual to permit the individual to have control over the design and review of the graphics content.

After roles have been assigned to the publisher personnel 125, the initial process for creating a new article 165 may start with the submission of a request to create the article 165. For example, an individual may fill out a form on an interface provided by the reverse publishing system 180 to submit the request. The request may identify the basic concept or premise for the article and some other general information pertaining to the proposed article. The requests may be forwarded to editors for approval or denial. For example, when the editor logged into the reverse publishing system 180 (e.g., via the back-end portion of the publication 160), the request and its associated information may be presented to the editor for review. In cases in which a request for a new article is submitted by an editor (e.g., an executive editor), the request may automatically be approved.

Once a request to create a new article 165 has been approved, an editor may assign tasks associated with creating the article content to one or more content contributors using the interfaces provided by the reverse publishing system 180. For example, the editor may assign one or more authors to draft the textual content for the article, one or more photographers to provide pictures for the article and one or more graphic designers to create graphics for the article. Other types of tasks may also be assigned (e.g., for creating videos, audio clips or other content for the article). The tasks may be assigned by the editor to the content contributors by explicitly selecting the content contributors or by using crowd sourcing techniques.

During the creation of the article 165, all interaction with the article is tracked and recorded by the reverse publishing system 180 and associated with the article. For example, the reverse publishing system 180 may record data indicating each time that an author, photographer, graphic designer, editor or other individual accesses, creates, revises, updates or contributes to an article 165. For each such interaction, the recorded data may identify, inter alia, the individual who was involved, the date and time that the event occurred and the stage of the workflow process in which the event occurred. This data may be made available to publisher personnel 125 via the back-end portion of a publication in order to track the article through the workflow process.

An initial draft of the article 165 being created may be sent to an editor for review. The editor may review the article, edit the article, send the article back to one or more of the content contributors for revisions and/or approve the article. In some cases, there may be several iterations or revisions of the draft which are passed between contributors and the editors. The reverse publishing system 180 may facilitate the transfer of the current article draft between the editors and the content contributors. Once the editor is satisfied with the article 165, the editor may select an option that indicates that the article is ready to be published via a digital publication 160 that is displayed to the end-users 105.

An editor or other individual associated with the article creation process may also provide a selection for converting the digital version of the article to a format for inclusion in a printed publication. This may involve extracting mark-up tags (e.g., HyperText Markup Language, Extensible Markup Language tags or other types of tags), style sheet data (e.g., associated with a Cascading Style Sheet) and/or application code from the digital version of the article 165. This may also include using the content associated with the digital version of the article to populate a template that was created for use in a publishing software application (e.g., Adobe InDesign™) that is configured to assist users with creating printed publications and/or printed articles 165. Populating the template may include mapping the article content (e.g., text, images, graphics, etc.) to pre-defined portions of the template and deleting article content that is not compatible with printed publications (e.g., videos and audio clips).

The reverse publishing system 180 may utilize crowd sourcing techniques to assist with tasks at various stages of the workflow process associated with creating an article 165. The crowd sourcing techniques permit a publisher 120 to take advantage of a labor pool that may be comprised of employees and/or independent contractors. Requests may be sent to individuals included in the labor pool to determine their availability with regard to performing certain tasks (e.g., authoring an article, taking photographs or generating graphics). The individuals in the labor pool may respond to the request by indicating whether or not they are available to handle or fulfill the request. An editor or other individual may assign the performance of the task to one or more individuals that have indicated that they are available to handle the request. In certain embodiments, the notifications sent to the individuals in the labor pool for requesting assistance with a task or for confirming assignment of a task may include an option that permits the individuals to automatically add a calendar event to a personal calendar (e.g., on their phone or associated with their e-mail account) that includes information about the task (e.g., time and location). In addition to allocating workflow tasks to individuals, the crowd sourcing techniques may also be applied to receive submissions pertaining to ideas for creating new articles 165. Each of these applications are described in further detail below.

The first application of the crowd sourcing techniques involves the assignment of a task to a content contributor (e.g., an author, photographer, graphics designer, video camera operator, video content editor, reporter, or other content contributor). For example, in the case of a breaking news story, an editor may wish to send a photographer to the scene of the event in order to record the event. To select the photographer, the editor may login to the back-end portion of the publication 160 and identify a listing of individuals who are photographers. The editor may then cause a notification or request to be transmitted to all or some of the identified photographers to provide assistance with the breaking news story. For example, the notifications may be transmitted to e-mail addresses retrieved from profiles for the photographers which are stored on the online publishing platform 150, or to an inbox for the photographers provided by the online publishing platform 150. The photographers may provide feedback indicating their availability (e.g., indicating if they are available to fulfill the request and how quickly they could do so) and current location. The feedback may be provided via the reverse publishing system 180 or, alternatively, by sending an e-mail or placing a phone call to the editor. The editor may then select one of the photographers to fulfill the request. For example, after receiving feedback from the photographers, the editor may select the photographer who is located closest to the scene where photographs are required. The reverse publishing system 180 may permit the editor to specify who is selected in order to notify the photographers that the task has been assigned and to permit the selected photographer to upload the photographs to the reverse publishing system 180. Similar techniques may be applied to assign tasks to any of the other content contributors, regardless of whether there is an immediate or urgent need for completing the task.

Another application of crowd sourcing permits concepts and ideas for creating new articles to be submitted to editors. For example, any publisher personnel 125 (regardless of whether they are an employee or independent contractor) that has an account associated with the publication 160 may be permitted to submit a request via the reverse publishing system 180 to create a new article 165. The request may include some basic information associated with the proposed article (e.g., description of the concept, title, timeframe for completion and recommended author). The requests may be made available to editors via the reverse publishing system 180 and the editors may determine whether to approve or deny the requests.

The description of FIGS. 22-29 illustrate exemplary interfaces associated with providing a reverse publishing system 180 according to certain embodiments of the present invention. The interfaces shown in these figures may be displayed to publisher personnel 125 or other individuals via the back-end portion of a publication 160.

FIG. 22 is an exemplary interface 2200 illustrating a listing of employee profiles 2220 for a publication 160 in accordance with certain embodiments of the present invention. The listing 2220 may include an entry for any publisher personnel 125, employee, staff member, independent contractor or other individual that is associated with the online publishing platform 150 or the publications 160. An add employee option 2210 permits additional employee profiles to be created. In response to an entry in the listing 2220 being selected, the contact section 2230 will display the contact information for the individual associated with profile. An entry in the listing may also be selected to permit the associated profile information to be edited.

FIG. 22A is an exemplary interface 2200A for editing a selected employee profile. A general information section 2210 includes an input form for identifying an alias (e.g., nickname), description, blurb and image for the individual associated with the profile. One or more roles may be assigned to the individual by selecting entries in the listing of roles 2230. As explained above, the roles assigned to an individual may be used by the reverse publishing system 180 in a variety of different ways to facilitate the creation or updating of an article 165. An address section 2340 permits entry of one or more addresses for the individual, a phone section 2350 permits entry of one or more phone numbers for the individual and an e-mail section 2260 permits entry of one or more e-mail addresses for individual. The contact information provided in these sections may be used by the reverse publishing system 180 to crowd source. For example, to assist with assigning a task to an individual, the reverse publishing system 180 may transmit e-mails to the identified e-mail addresses or place automated phone calls to the identified phone numbers.

Publisher personnel 125 and other individuals may be permitted to login to the back-end portion of a publication in order to assist with the creation of articles for the publications 160 and to perform other functions. A login section 2200 displays information associated with the individual's user account login information (e.g., username and security question). The login section 2200 also indicates whether the individual is currently logged into a user account and whether the individual is approved to perform services associated with a publication 160.

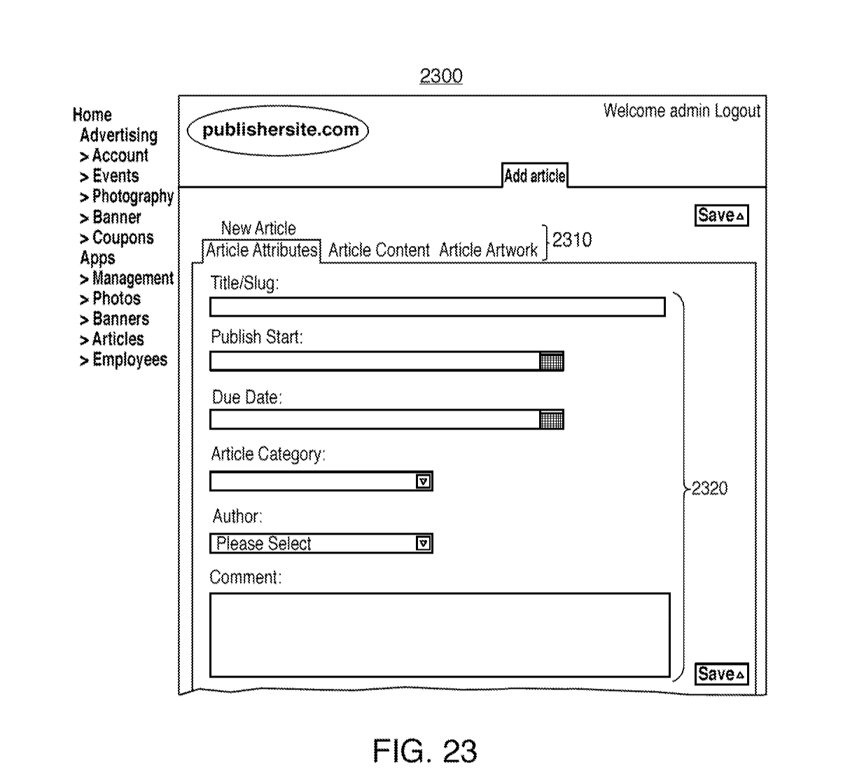

FIG. 23 is an exemplary interface 2300 for creating a new article 165. In certain embodiments, an editor may fill out the attribute form 2320 to permit entry of some general information associated with the article being created. For example, the attribute form 2320 may permit the editor to specify the title of the article, the intended publication date for the article and the intended due date for completing the article. The comments section may be used to describe the basic idea or concept for the article. The form 2320 may also permit the editor to assign an author to create the article and to select a category for the article that indicates the genre of the article content (e.g., which may indicate that the article is directed to sports, nightlife or politics).

As mentioned above, the publisher personnel 125 or other individuals may submit requests to create new articles in accordance with the crowd sourcing features that are facilitated by the reverse publishing system 180. An individual requesting consideration of a proposed article topic may be presented with a similar interface which permits the individual to specify a suggested title and category for the article, as well as to provide a description of the basic idea or concept behind the article 165.

The interface 2300 also includes a menu of options 2310. The first option on the menu 2310 is currently selected. Selection of the other options on the menu 2310 permits text, photos, artwork and other content to be added to the article being created.

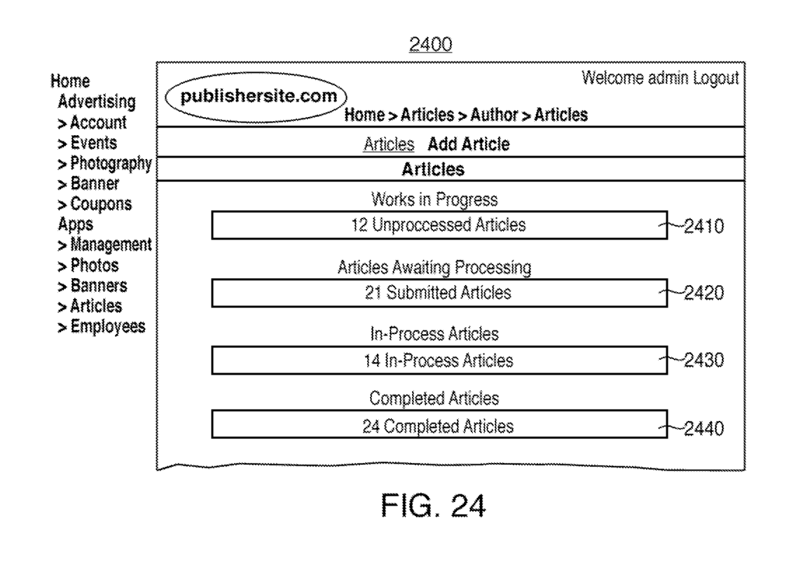

FIG. 24 is an exemplary interface 2400 illustrating the status of articles for a publication 160. The interface 2400 indicates the number of articles at different stages of the workflow process. For example, a first stage indicator 2410 identifies how many articles have been approved and are in the progress of being created. A second stage indicator 2420 indicates how many articles are awaiting processing 2420 (e.g., which may include proposed article submissions that were provided through crowd sourcing and which have not yet been examined by an editor for approval). A third stage indicator 2430 identifies how many articles are in-process and a fourth stage indicator 2440 identifies how many articles have been completed. Any of the indicators may be selected to view a listing of the articles associated with the indicator. In certain embodiments, the indicators may be divided into stages of the workflow process in a more detailed manner or may include sub-categories associated with each of identified stages.

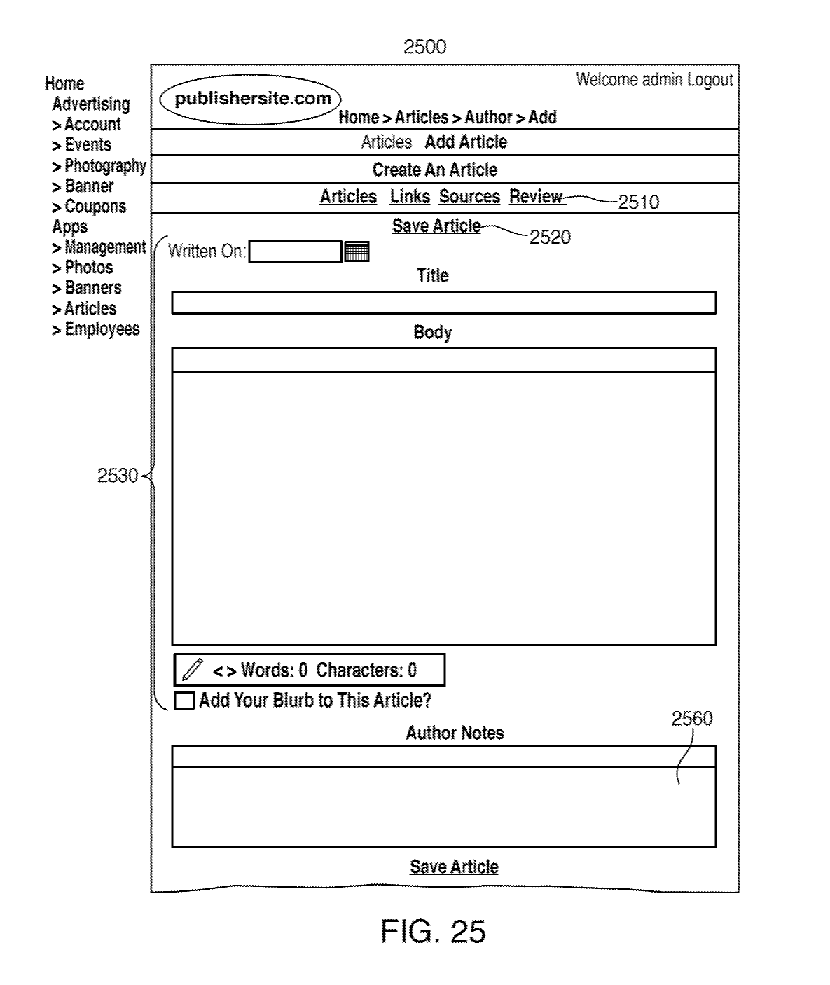

FIG. 25 is an exemplary interface 2500 for adding content to an article 165. A content input form 2530 permits an author or other individual to specify a title for the article, draft the textual portion of the article and indicate a date and time when the content was provided. The content input form 2530 may also include an indicator that identifies how many words and/or characters are included in the content of the article. A blurb section 2560 permits the author to enter a short blurb that provides a summary or brief description for the article 165. The blurb may be displayed when the article is eventually published in a listing of other articles in order to provide readers or end-users 105 with a quick summary of the article 165. A menu 2510 of options permits the individual drafting the article to specify sources for the article, identify links associated with the article and to review the draft of the article 165. Selecting a save option 2520 may permit the draft of the article to be saved on the publishing server 140.

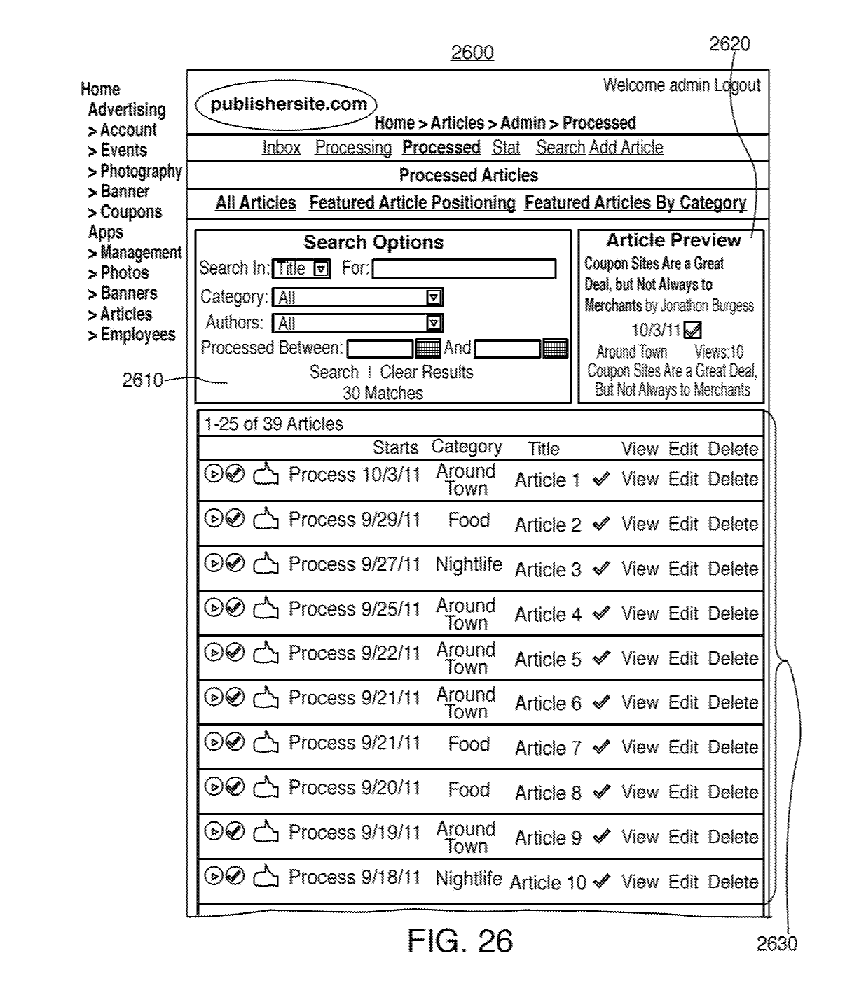

FIG. 26 is an exemplary interface 2600 for managing articles for a publication 160. The interface 2600 includes a listing of processed articles 2630. For each entry, the listing identifies the title, category and the start date for publishing the article 165. Each entry in the listing 2630 includes options that may be selected in order to view, edit or delete the articles. The interface also includes a search section 2610 that allows for filtering of the articles displayed in the listing 2630 based on the criteria illustrated. An article preview section 2620 displays a summary of information associated with a selected entry in the listing. For example, the article preview section 2620 displays the name of the article, author, start date and number of times the article has been viewed by end-users 105.

The top of the interface 2600 also includes a menu that links to other interfaces that are also configured to assist with managing the articles for a publication 160. For example, the options on the menu may link to a similar interface that displays a listing of incomplete articles that are still under processing, an interface that permits new articles to be created (e.g., such as FIG. 23), an interface that provides statistics associated with articles that have been published (e.g., indicating how many end-users 105 have viewed the articles), an interface that is used to search for articles and an interface for an inbox that displays a listing of incoming messages and notifications for the individual accessing the interface 2600.

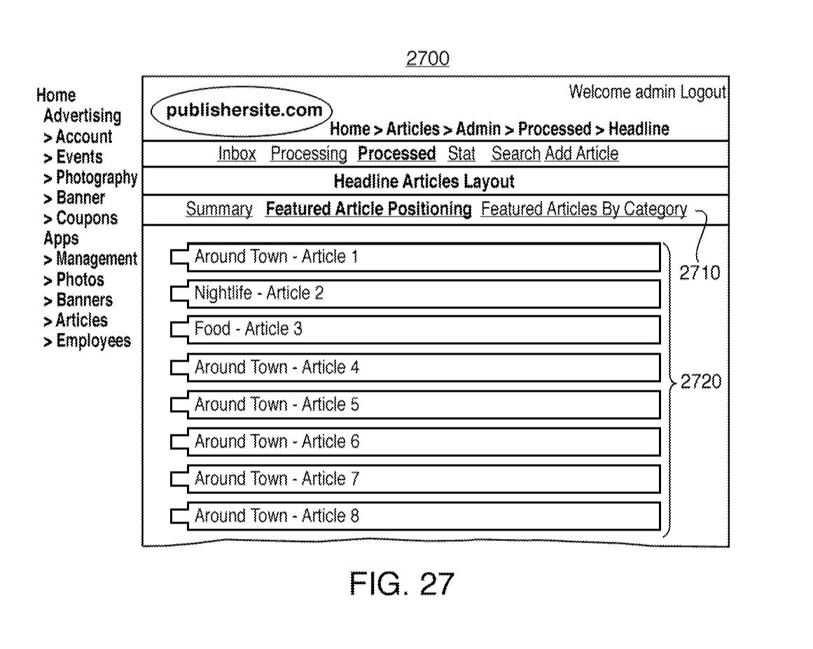

FIG. 27 is an exemplary interface 2700 for managing the positioning of featured articles for a publication 160. The interface includes a listing of featured articles 2720. Each entry in the listing 2720 may represent an article that was created using the reverse publishing system 180. The ordering of the entries may be used to determine the priority of the articles and where the articles will appear on the publication 160. For example, the article located at the top of listing 2720 may be given the greatest priority and may be displayed as the headline story to end-users 105 who access the publication 160, while the article at the bottom of the listing 2720 may be given lower priority and may appear in a portion of the publication 160 which is less visible or obscure. A menu 2710 located at the top includes an option that provides a summary of the featured articles presented on the publication and a second option that categorizes the featured articles based by the category (e.g., sports or politics) assigned to the articles 165.

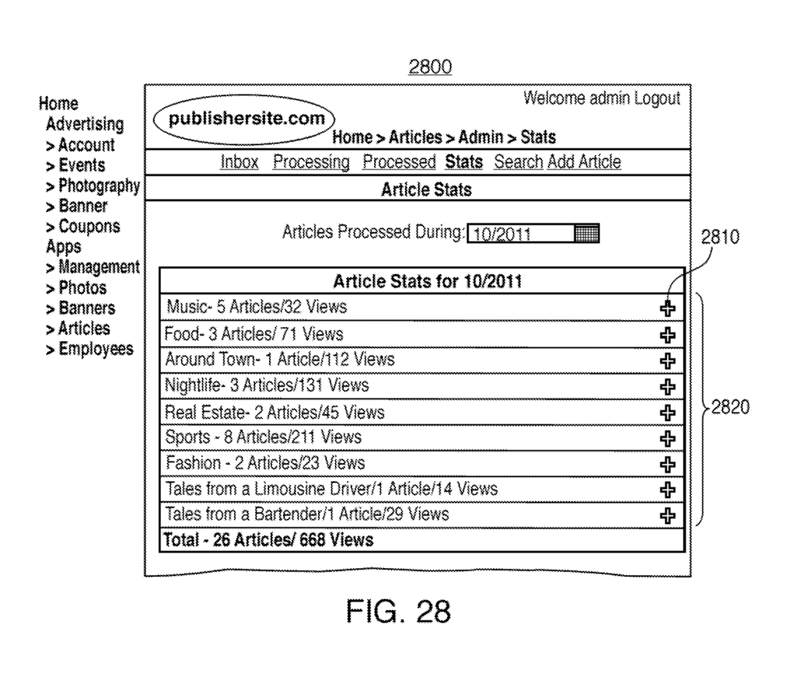

FIG. 28 is an exemplary interface 2800 for displaying statistical information associated with articles in a publication 1600. The online publishing platform 150 may track all activities associated with end-users 105 viewing and/or interacting with the articles provided for the publications 160. The interface 2800 includes a listing 2820 that includes entries organized according categories (e.g., music, food, nightlife and fashion) that are assigned to the articles. Each entry identifies how many articles are associated with each category and the total number of views for the articles in the category. Each entry also includes a details option 2810 that expands to show additional statistics when selected. For example, selecting the details option 2810 for the first entry may display a listing of all the articles that have been tagged with the “Music” category and the number of views for each article 165.

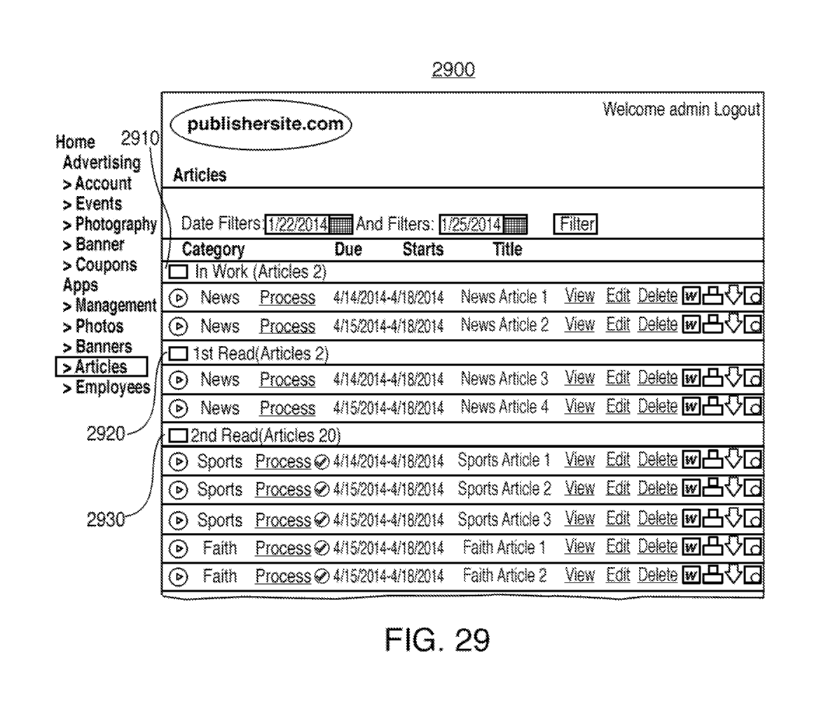

FIG. 29 is an exemplary interface 2900 illustrating a listing of pending articles organized according to their workflow stage. The articles 165 in the listing are organized according into three categories: an in-work category 2910 that includes articles in which the initial draft is still being created; a first read category 2920 that includes articles in which a first draft has been created; and a second read category 2920 that includes articles 165 in which a second draft has been created. Scrolling down on this interface would show additional categories.

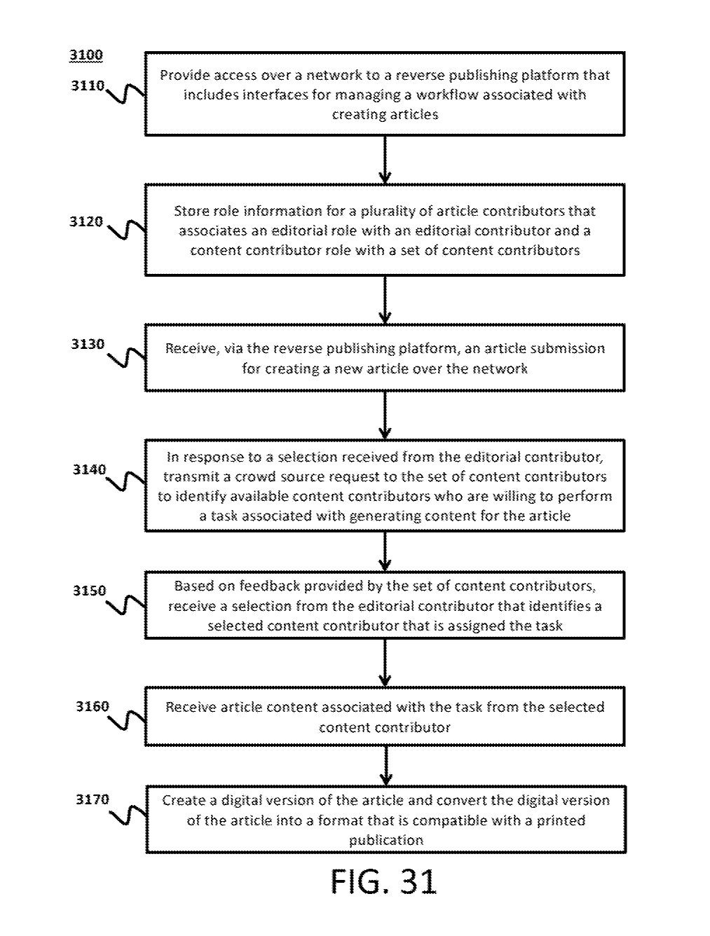

FIG. 31 is a flow chart of a method 3100 for providing a reverse publishing system 180 in accordance with certain embodiments of the present invention. Access is provided over a network to a reverse publishing platform 180 (e.g., the reverse publishing system 180 hosted on the server 140) that includes interfaces for managing a workflow associated with creating articles (step 3110). For example, an individual may access the reverse publishing system 180 by navigating to a URL associated with the reverse publishing platform and entering login credentials (e.g., username and password). Role information is stored for a plurality of article contributors (step 3120). The role information may associate an editorial role with an editorial contributor (e.g., an editor that works for a publisher 120) and a content contributor role with a set of content contributors. The content contributors may include authors, photographers, graphic designers, video editors, video camera operators or any other person that contributes to the content of an article 165.

An article submission is received via the reverse publishing platform for creating a new article over the network (step 3130). The article submission may be submitted by any individual, including any of the contributors or editors associated with a publication. In response to a selection received from the editorial contributor, a crowd source request is transmitted to the set of content contributors to identify available content contributors who are willing to perform a task associated with generating content for the article (step 3140). For example, the crowd source request may be sent to authors to identify available authors who are willing to create an article, to photographers to identify available photographers who are willing to take photographs for an event, or to graphic designers to identify available graphic designers who are willing to create graphics or artwork.

Based on feedback provided by the set of content contributors, a selection is received from the editorial contributor that identifies a selected content contributor that is assigned the task (step 3150). For example, in response to an editor submitting a crowd source request to a group of photographers, the photographers may provide feedback that indicates whether they are available and willing to assist with the task. The editor may then select the photographer who is best suited to execute the task (e.g., based on the photographer's location, experience and/or cost). Article content associated with the task is then received from the selected content contributor (step 3160). For example, after the selected photographer has taken pictures, the photographer may login to the reverse publishing system 180 and upload the photographs. The content may be used to create a digital version of the article and the digital version of the article may then be converted into a format that is compatible with a printed publication (step 3170). As explained above, this may involve exporting the digital version of the article to a publishing software application that is configured to create the printed publication.

While there have shown and described and pointed out various novel features of the invention as applied to particular embodiments thereof, it will be understood that various omissions and substitutions and changes in the form and details of the systems and methods described and illustrated, may be made by those skilled in the art without departing from the spirit of the invention. Amongst other things, the steps shown in the methods may be carried out in different orders in many cases where such may be appropriate. Those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the particular system components shown in the figures are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation.

1. A system for presenting advertiser content to end-users via an online publication, comprising:
(a) a first set of client devices associated with a plurality of advertisers, the first set of client devices being configured to:
receive selections, via input devices, from the plurality of advertisers pertaining to a plurality of advertising options that permit the advertisers to define advertising campaigns internally within the online publication; and
transmit the selections associated with the plurality of advertising options over a network;
(b) a server device having a processor and physical memory, the physical memory storing instructions that cause the processor to:
provide access to an advertiser marketplace directly through a front-end portion of the online publication that is accessible to end-users, wherein the advertiser marketplace comprises a plurality of interfaces that are configured to display separate categories of advertiser content internally within the online publication itself in accordance with the advertising campaigns and without requiring the end-users to navigate to external websites to access the advertiser content, the categories of advertiser content including categories associated with coupon information, photo album information, calendar information and directory listing information;
receive the selections associated with the plurality of advertising options over the network from the first set of client devices;
store profile information for the plurality of advertisers on a non-transitory computer storage medium, the profile information at least including:
advertising campaign information associated with the advertising options selected by the plurality of advertisers;
information pertaining to the categories of advertiser content; and
start dates indicating when the advertisers created user accounts associated with the advertiser marketplace;
receive a request, via the front-end portion of the online publication, from an end-user to display an interface associated with the advertiser marketplace;
aggregate advertiser content for a plurality of advertisers that includes a subset of the stored profile information pertaining to a category of the advertiser content that is associated with the interface identified by the end-user's request; and
transmit a listing of entries over the network for display to the end-user that includes the aggregated advertiser content, wherein an ordering of the entries in the listing is determined, at least in part, by:
assigning priority rankings to the advertisers based on advertising expenditures, wherein advertising expenditures for each advertiser are computed by identifying the advertising options that were selected by the advertiser in defining an advertising campaign and summing amounts expended on each of the selected advertising options;
identifying advertisers that are assigned an identical priority ranking;
utilizing the start dates associated with the user accounts to determine which of the identified advertisers are to be given a higher priority ranking;
ordering the entries in the listing based on the priority rankings assigned to the advertisers;
determining whether any of the advertisers purchased a featured advertisement option that automatically causes entries associated with the advertisers to be placed at a top of the listing for a particular time period regardless of the priority rankings that otherwise would have been assigned to the advertisers; and
if two or more advertisers purchased a featured advertisement option for the same time period, utilizing the start dates to determine an ordering of the entries for those advertisers; and
(c) a second client device associated with the end-user that is configured to receive the listing of entries over the network and display the listing of entries to the end-user internally through the front-end portion of the online publication.

2. (canceled)

3. The system of claim 1, wherein the advertisers that spend larger amounts on advertising expenditures are given higher priority rankings in comparison to the advertisers that spend smaller amounts on advertising expenditures.

4. The system of claim 1, wherein computing the advertising expenditures includes:
identifying all pending contracts that govern present relationships between the advertisers and a publisher associated with the advertiser marketplace; and
summing values for the identified contracts for each of the advertisers.

5. The system of claim 1, wherein the user accounts permit the advertisers to transmit requests to a publisher associated with the advertiser marketplace for assistance with scheduling entertainers or photographers and the publisher utilizes a crowd sourcing feature to schedule the entertainers or photographers.

6. The system of claim 1, wherein the advertisers may access the user accounts to create or update the profile information.

7. The system of claim 1, wherein the entries in the listing include filtering options that are used to narrow the entries in the listing based on one or more of:
locations associated with the advertisers;
types of businesses associated with the advertisers; and
venues associated with events that are hosted by the advertisers.

8. The system of claim 1, wherein the aggregated advertiser content is generated substantially in real-time in response to receiving the request submitted by the end-user.

9. The system of claim 1, wherein the aggregated advertiser content is generated at periodic intervals and stored for subsequent retrieval at a time that the request is submitted by the end-user.

10. The system of claim 1, wherein a publisher associated with the advertiser marketplace is provided access to an account that permits the publisher to create and update the profile information for the advertisers.

11. A method for presenting advertiser content to end-users via an online publication, comprising:
receiving selections, over a network, from a first set of client devices associated with a plurality of advertisers, the selections pertaining to a plurality of advertising options that permit the advertisers to define advertising campaigns within the online publication;
providing access to an advertiser marketplace directly through a front-end portion of the online publication that is accessible to end-users, wherein the advertiser marketplace comprises a plurality of interfaces that are configured to display separate categories of advertiser content internally within the online publication itself in accordance with the advertising campaigns and without requiring the end-users to navigate to external websites to access the advertiser content, the categories of advertiser content including categories associated with coupon information, photo album information, calendar information and directory listing information;
storing profile information for the plurality of advertisers on a non-transitory computer storage medium, the profile information at least including:
advertising campaign information associated with the advertising options selected by the plurality of advertisers;
information pertaining to the categories of advertiser content; and
start dates indicating when the advertisers created user accounts associated with the advertiser marketplace;
receiving a request, via the front-end portion of the online publication, from an end-user to display an interface associated with the advertiser marketplace;
aggregating advertiser content for a plurality of advertisers that includes a subset of the stored profile information pertaining to a category of the advertiser content that is associated with the interface identified by the end-user's request; and
transmitting a listing of entries over the network for display to the end-user that includes the aggregated advertiser content, wherein an ordering of the entries in the listing is determined, at least in part, by:
assigning priority rankings to the advertisers based on advertising expenditures, wherein advertising expenditures for each advertiser are computed by identifying the advertising options that were selected by the advertiser in defining an advertising campaign and summing amounts expended on each of the selected advertising options;
identifying advertisers that are assigned an identical priority ranking;
utilizing the start dates associated with the user accounts to determine which of the identified advertisers are to be given a higher priority ranking;
ordering the entries in the listing based on the priority rankings assigned to the advertisers;
determining whether any of the advertisers purchased a featured advertisement option that automatically causes entries associated with the advertisers to be placed at a top of the listing for a particular time period regardless of the priority rankings that otherwise would have been assigned to the advertisers; and
if two or more advertisers purchased a featured advertisement option for the same time period, utilizing the start dates to determine an ordering of the entries for those advertisers;
wherein the listing of entries is received by a second client device associated with the end-user and the second client device is configured to display the listing of entries to the end-user internally via the front-end portion of the online publication.

12. (canceled)

13. The method of claim 11, wherein the advertisers that spend larger amounts on advertising expenditures are given higher priority rankings in comparison to the advertisers that spend smaller amounts on advertising expenditures.

14. The method of claim 11, wherein computing the advertising expenditures includes:
identifying all pending contracts that govern present relationships between the advertisers and a publisher associated with the advertiser marketplace; and
summing values for the identified contracts for each of the advertisers.

15. The method of claim 11, wherein the user accounts permit the advertisers to transmit requests to a publisher associated with the advertiser marketplace for assistance with scheduling entertainers or photographers and the publisher utilizes a crowd sourcing feature to schedule the entertainers or photographers.

16. The method of claim 11, wherein the advertisers may access the user accounts to create or update the profile information.

17. The method of claim 11, wherein the entries in the listing include filtering options that are used to narrow the entries in the listing based on one or more of:
locations associated with the advertisers;
types of businesses associated with the advertisers; and
venues associated with events that are hosted by the advertisers.

18. The method of claim 11, wherein the aggregated advertiser content is generated substantially in real-time in response to receiving the request submitted by the end-user.

19. The method of claim 11, wherein the aggregated advertiser content is generated at periodic intervals and stored for subsequent retrieval at a time that the request is submitted by the end-user.

20. The method of claim 11, wherein a publisher associated with the advertiser marketplace is provided access to an account that permits the publisher to create and update the profile information for the advertisers.

21. A non-transitory computer storage medium comprising a computer readable program for presenting advertiser content to end-users via an online publication, wherein the computer readable program when executed on a computer causes the computer to:
receive selections, over a network, from a first set of client devices associated with a plurality of advertisers, the selections pertaining to a plurality of advertising options that permit the advertisers to define advertising campaigns within the online publication;
provide access to an advertiser marketplace directly through a front-end portion of the online publication that is accessible to end-users, wherein the advertiser marketplace comprises a plurality of interfaces that are configured to display separate categories of advertiser content internally within the online publication itself in accordance with the advertising campaigns and without requiring the end-users to navigate to external websites to access the advertiser content, the categories of advertiser content including categories associated with coupon information, photo album information, calendar information and directory listing information;
store profile information for the plurality of advertisers on a non-transitory computer storage medium, the profile information at least including:
advertising campaign information associated with the advertising options selected by the plurality of advertisers;
information pertaining to the categories of advertiser content; and
start dates indicating when the advertisers created user accounts associated with the advertiser marketplace;
receive a request, via the front-end portion of the online publication, from an end-user to display an interface associated with the advertiser marketplace;
aggregate advertiser content for a plurality of advertisers that includes a subset of the stored profile information pertaining to a category of the advertiser content that is associated with the interface identified by the end-user's request; and
transmit a listing of entries over a network for display to the end-user that includes the aggregated advertiser content, wherein an ordering of the entries in the listing is determined, at least in part, by:
assigning priority rankings to the advertisers based on advertising expenditures, wherein advertising expenditures for each advertiser are computed by identifying the advertising options that were selected by the advertiser in defining an advertising campaign and summing amounts expended on each of the selected advertising options;
identifying advertisers that are assigned an identical priority ranking;
utilizing the start dates associated with the user accounts to determine which of the identified advertisers are to be given a higher priority ranking;
ordering the entries in the listing based on the priority rankings assigned to the advertisers;
determining whether any of the advertisers purchased a featured advertisement option that automatically causes entries associated with the advertisers to be placed at a top of the listing for a particular time period regardless of the priority rankings that otherwise would have been assigned to the advertisers; and
if two or more advertisers purchased a featured advertisement option for the same time period, utilizing the start dates to determine an ordering of the entries for those advertisers;
wherein the listing of entries is received by a second client device associated with the end-user that is configured to display the listing of entries to the end-user internally via the front-end portion of the online publication.
